(19) United States
(12) Patent Application Publication
(10) Pub. No.: US 2011/0275038 A1
(43) Pub. Date: Nov. 10, 2011

(54) Educational Math Game

(76) Inventor: Willi Penner, Calgary (CA)

(21) Appl. No.: 12/776,418

(22) Filed: May 9, 2010

(51) Int. Cl. G09B 23/02

(52) U.S. Cl. 434/188

(57) ABSTRACT

An educational game for mathematics has a poly outline or spherical shape board with a continuous play path along its edge and is labeled with different mathematical strands. Strands include question cards, segments labeled as mathematical concepts, and a monetary amount. Game pieces are included but are not part of the game board itself. When a player tosses a positive integer with both dice (E.g. cube subtracted from decahedron) and lands on a segment, he/she will receive credit for correctly answering a strand card question. If the dice toss result is negative, he/she may not attempt a question. If segments are credited to other players, he/she must pay a penalty derived from a mathematical equation. Players will have opportunities to place desks/tables on their credited segments. Greater fees occur with desks/tables present. Players track losses/gains on a money tracking card. The player with the most amount of money after a set time, or a player who has made all other players forfeit wins the game. A means of playing the present game is also disclosed.

### BACKGROUND OF INVENTION

1. Field of the Invention

This invention relates to games of mathematical skills in general, and more specifically to a mathematical game upon which may be played by two or more players. It is begun by placing the Game Board, Mental Math, Problem Solving, Statistic and Probability and Patterns and Relation cards face down on their allotted spaces on the game board playing surface. Each player chooses one token to represent him/her for game play. All players will receive a $250 money tracking card. This card will help the player keep track of money paid for segments or for incoming money paid by other players. A secretary may watch over the money being exchanged and also to clarify the rules to other players if there is a discrepancy. The secretary could be one of the existing players or may be delegated to a player who chooses to just play the role of secretary. The game ends upon an agreed time of termination when the most decorated player is determined the winner or when all other players are declared on sabbatical by not having the funds to continue playing the game.

2. Description of the Related Art

Many different age groups have enjoyed mathematical games for many years. Mathematical games and its uses are well recognized in the prior art. More specifically, mathematical games that have been devised and utilized over the years are known to consist of familiar, expected, and obvious structural configurations despite the countless designs encompassed by the crowded prior art, which have been developed for the fulfillment of countless objectives and requirements. Advancing a player's token from a start position to a finish position while answering questions along a path according to the roll of a players die almost universally plays such games.

Scoring consist of having the first player to whom successfully advances their marker to finish position be declared winner of the game.

Advancing a player's marker according to the numeric value of the die or dice almost usually scores these types of games. Very few, if any Mathematical games have been developed over the years which use the two die method to determine a positive or negative advancement on game board by subtracting the smaller die value from greater die value, move a token accordingly, answering questions along the way and with the most decorated player or sending players into sabbatical wins the game Any related art forms known to the present inventor are listed below.

| | | |
|---|---|---|
| U.S. Pat. No. 1,604,846 | U.S. Pat. No. 5,102,339 | U.S. |
| | | Pat. No. 5,782,471 |
| U.S. Pat. No. 3,104,106 | U.S. Pat. No. 5,242,171 | U.S. |
| | | Pat. No. 5,318,447 |
| U.S. Pat. No. 4,109,918 | U.S. Pat. No. 4,557,485 | U.S. |
| | | Pat. No. 5,679,002 |

### SUMMARY OF INVENTION

The present mathematical game includes a playing surface, two dice, (e.g. cube, dodecahedron), plurality of players tokens, desks, group tables, mental math cards, problem solving cards, strand questions and money tracking cards. Also included in game board is a title deed card for each segment, formula sheet, answer sheet, graph paper, scrap paper, ruler and protractor.

The object of the game is to earn as many complete math segments as possible or to posses the most amount of money at the conclusion of game depending on method of play and to learn and strengthen mental math and problem solving skills; by tossing two dice resulting in a positive or negative integer and moving a player's token along a peripheral path, therefore landing on a designated segment resulting in a mathematical question being asked and possibly giving credit to player if correctly answered unless segment has already been earned by another player resulting in a payment issued to that player.

Each player continues his/her turn; by tossing two dice resulting in a positive or negative integer and moving a player's token along a peripheral path, therefore landing on a designated segment resulting in a mathematical question being asked and possibly giving credit to player if correctly answered unless segment has already been earned by another player resulting in a payment issued to that player. Play then passes to next player who continues playing the same game as previous player. A timer may be used to determine the winner as the player with the most math credits earned or sending player's into sabbatical when the time limit has expired winning the game.

Different mathematical cards, problem solving cards, strand questions and types of die may be used in the present game, ranging from one tetrahedron die having four faces to and including one icosahedron having twenty faces or any other shape die may be used as desired.

The present mathematical game also includes different embodiments of a playing apparatus, comprising a game board with different board configurations. (I.e. circular, rectangular, square, etc.) The tokens, card sets, protractor, rulers, desks, group tables, formula, answer sheets, graph paper and scrap paper maybe actuated by means of mechanical, electrical, electronic, or other suitable means available.

Accordingly, it is a principal object of the present invention to provide a mathematical game. The mathematical game comprising of a playing surface, two dice, (e.g. cube, dodecahedron), plurality of players tokens, desks (N), group tables, mental math cards, problem solving cards, strand questions and money tracking cards and a title deed card for each segment, formula sheet, answer sheet, graph paper, scrap paper, ruler and protractor.

Another object of the present invention is to provide a mathematical game in which a predetermined time limit maybe set, with the winner being the player having the most math credits earned when the time limit has expired winning the game.

In addition, another object of the present invention is to provide a mathematical game that may also be adapted for low vision, visually impaired or blind players by means of Braille indicia.

It is therefore an object of the present invention to provide a new mathematical game which is of durable, dependable and of reliable construction that may be manufactured from wood, plastic, paper or any other suitable material available.

As such, the general purpose of the present invention, which shall be described subsequently in detail, is to provide a new educational mathematical game that has all the advantages of the prior art and none of the disadvantages.

These together with other objects of the invention, along with the various features of novelty that characterize the invention described, with particularity in the claims annexed to and forming a part of this disclosure.

For a better understanding of the invention, its operating advantages and the specific objects attained by its uses, references shall be made to the accompanying drawings and descriptive matter in which there are illustrated preferred embodiments of the invention.

### BRIEF DESCRIPTION OF DRAWINGS

FIG. 1 provides a perspective view of a first embodiment of a game board (T); which may be used for play in the present game. The board (T) includes a plurality of segments (E) and a plurality of inner segments (F) surrounding a surface (U) for tossing dice thereupon. (Example cubical die (R) and decahedron die (S) to generate random integers.) Each of the segments (E) and inner segments (F) are positioned on a continuous path along outer perimeter of game board (T).

The board game further includes a plurality of Mental Math cards (A), a plurality of Problem Solving cards (B), a plurality of Statistics and Probability cards (C), a plurality of Numbers cards (V), a plurality of Pattern and Relation cards (W), a plurality of Shape and Space cards (X), Shape and Space Path (G), Number Path (G1), Patterns and Relations Path (G2), Statistics and Probability Path (G3) and a location for board game name/logo (D).

FIG. 1a provides a perspective view of a first embodiment of a game board (T) in Braille; which may be used for play in the present game. The board (T) includes a plurality of segments (E) and a plurality of inner segments (F) surrounding a surface (U) for tossing dice thereupon. (Example cubical die (R) and two cubical Braille dice (S) to generate random integers.) Each of the segments (E) and inner segments (F) are positioned on a continuous path 130 along outer perimeter of game board (T). The board game further includes a plurality of Mental Math cards (A), a plurality of Problem Solving cards (B), a plurality of Statistics and Probability cards (C), a plurality of Numbers cards (V), a plurality of Pattern and Relation cards (W), a plurality of Shape and Space cards (X), Shape and Space Path (G), Number Path (G1), Patterns and Relations Path (G2), Statistics and Probability Path (G3) and a location for board game name/logo (D).

FIGS. 2, 2a & 2b provides a perspective view of a Title Deed answer key.

FIGS. 2c, 2d & 2e provides a perspective view of a Title Deed answer key in Braille.

FIG. 3 provides a perspective view of a Line Graph (I), player tokens (O), Protractor (P), Ruler (Q), money tracking card (K), Title deed card (L), Group Table (M), Desk (N). The Line Graph (I) is to be referred to when a question is given pertaining to information needed in order to solve a graphing question. Player tokens (O) are assigned to individual players to be utilized for game play. The Protractor (P) is to be used when a question is given pertaining to angles in order to solve an angle question. The Ruler (Q) is to be used when a question is given pertaining to measurement in order to solve a measurement question.

The Money Tracking card (K) is labeled with a predetermined amount of money which must be used by each individual player for calculating transactions incurred during game play. The Title deed card (L) is to be given to players that have ownership of a designated segment (S) and used for reference for fees owed by other players that have his/her token (O) positioned on the designated segment. The Group table (M) may be purchased during players turn to take the place of four (4) desks (N) and to be placed on designated segments. The Desk(s) (N) may be purchased during players turn when a completed mathematical unit has been earned and may be purchased individually to a maximum of four (4).

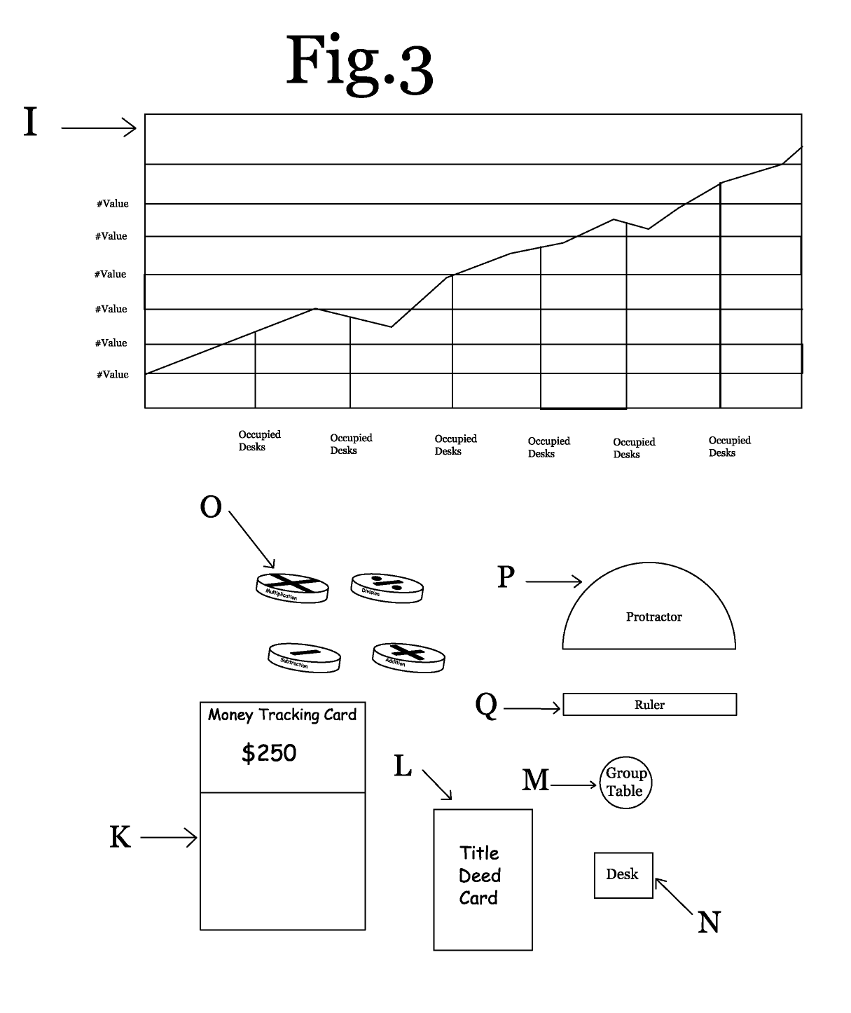

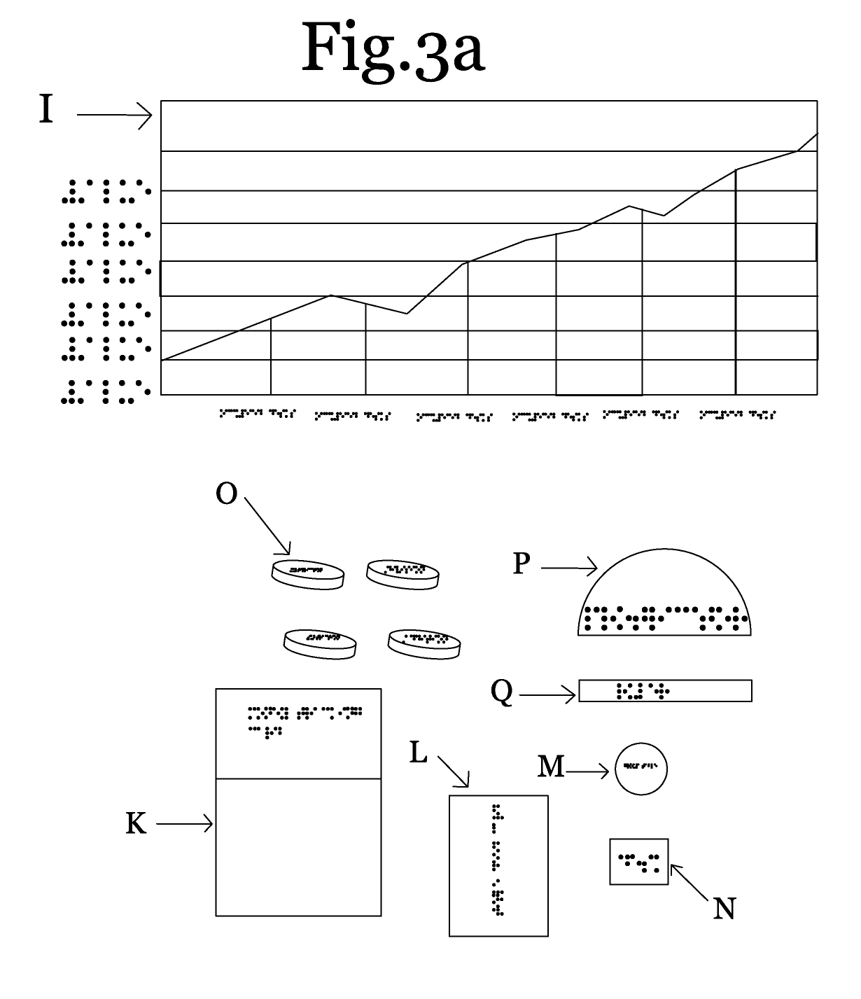

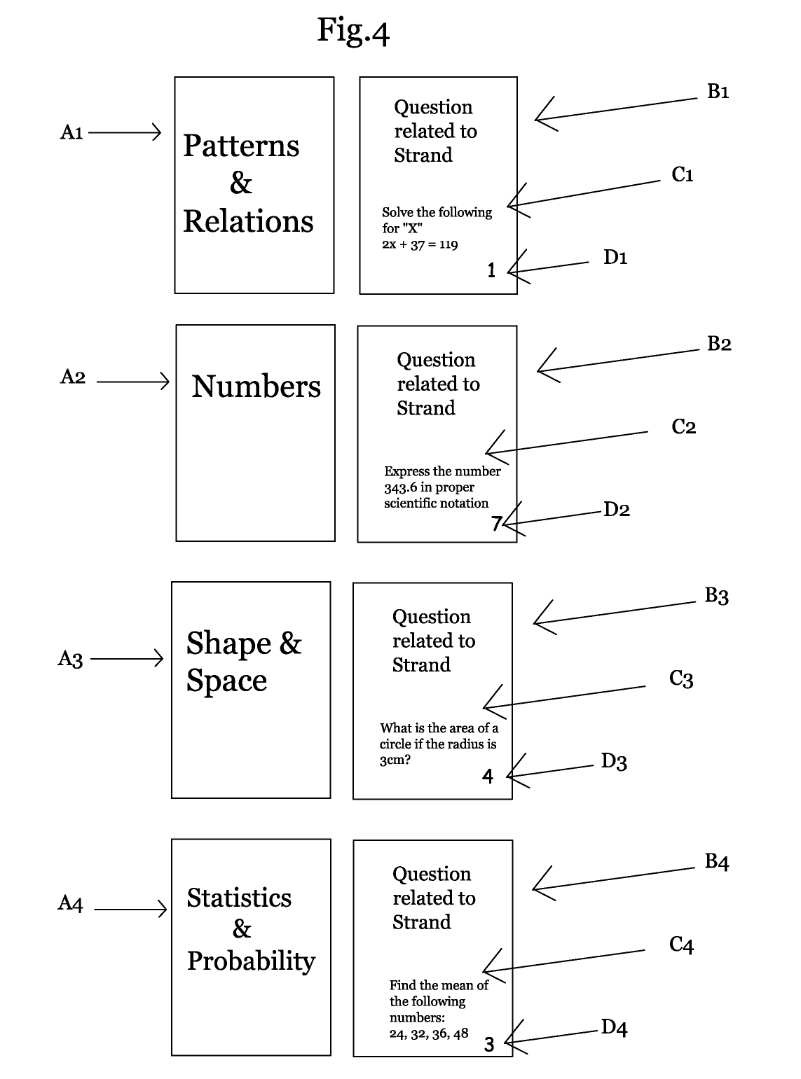

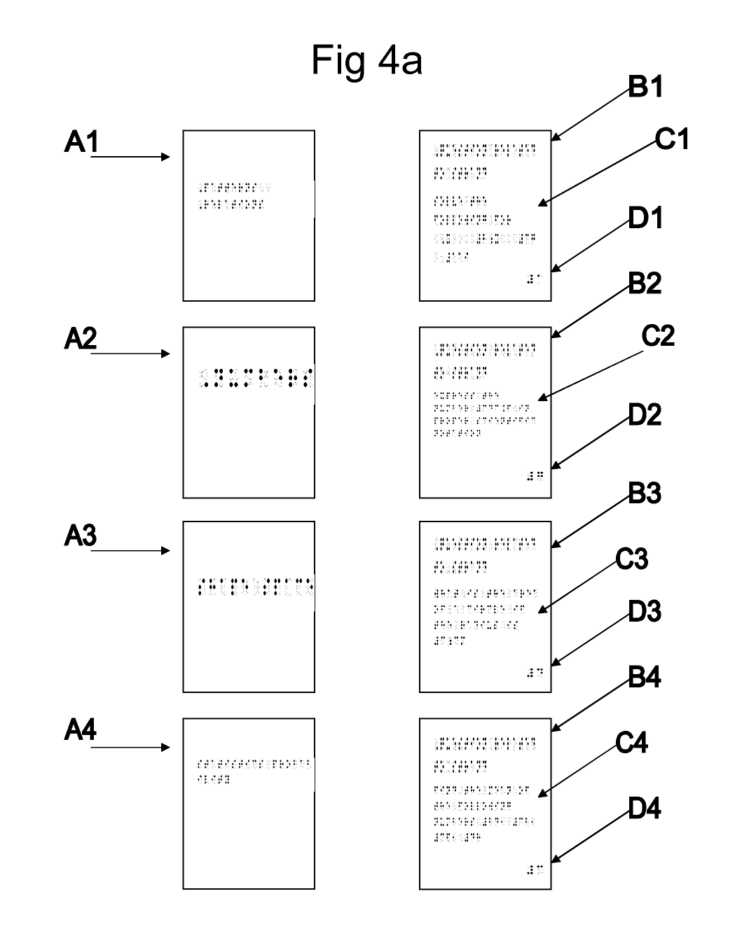

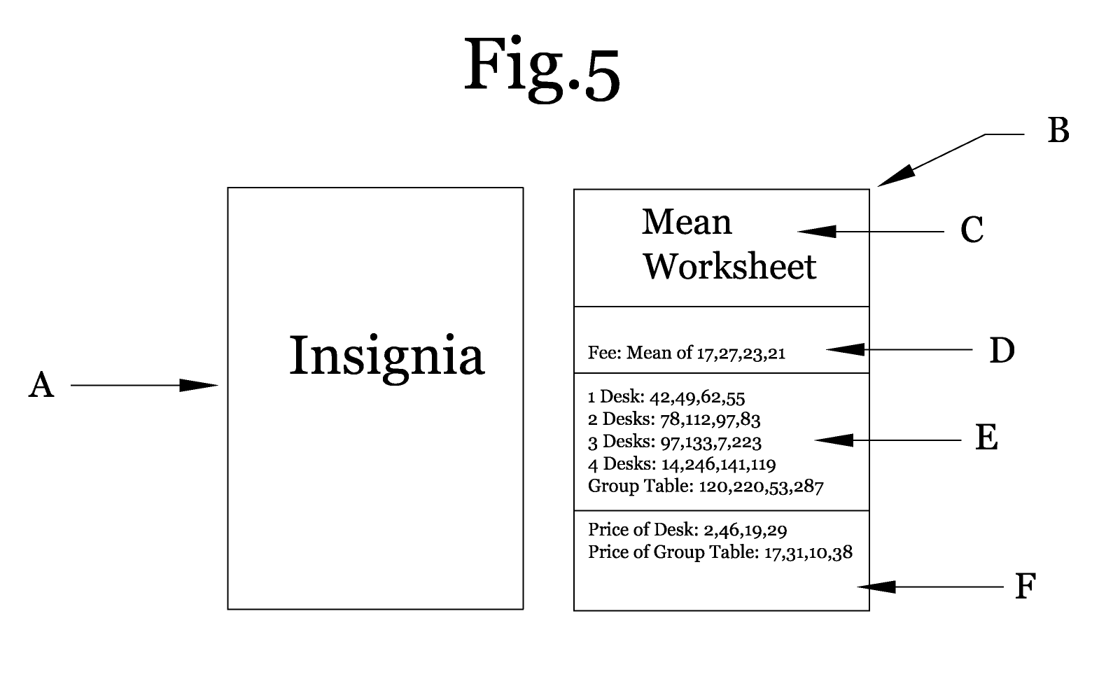

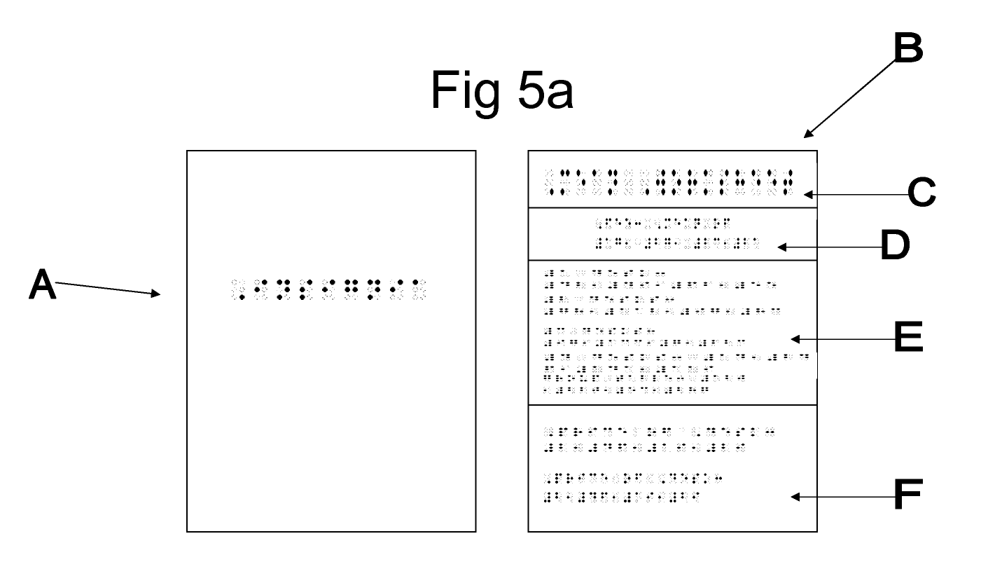

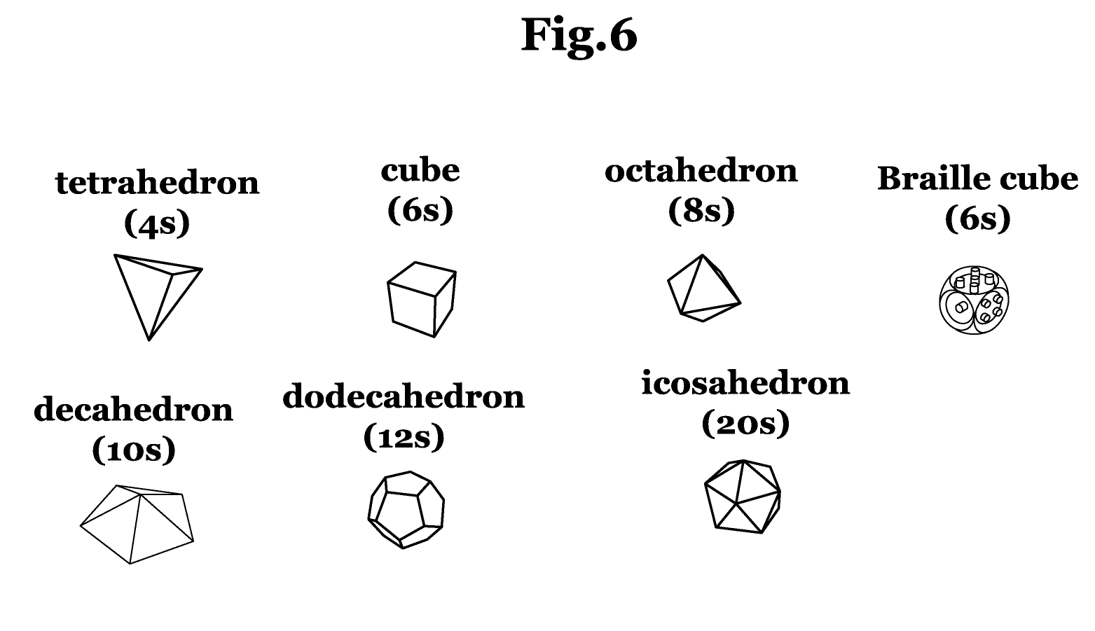

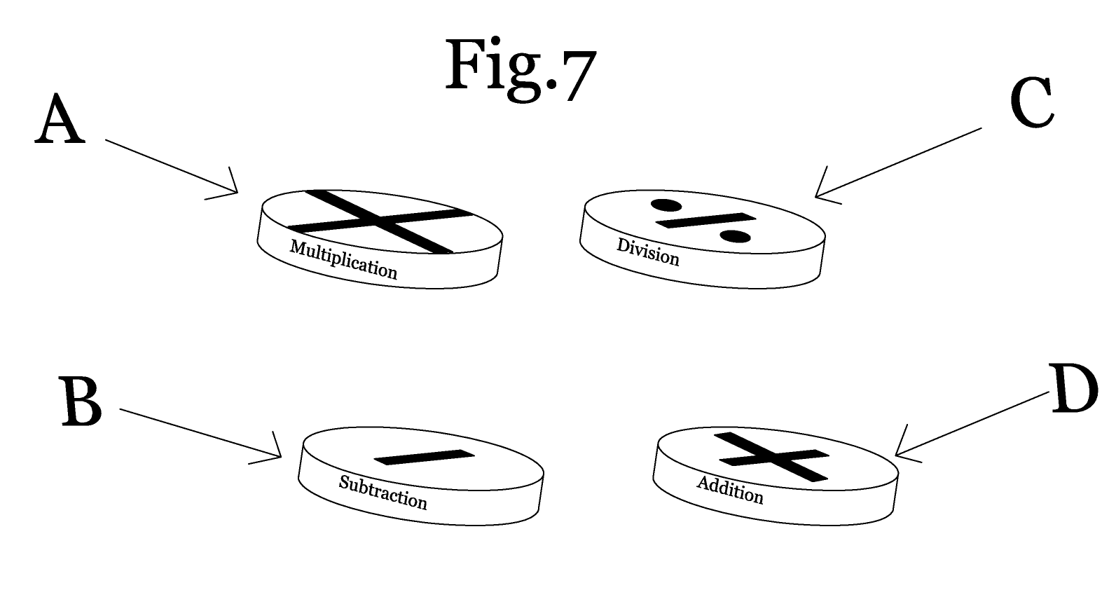

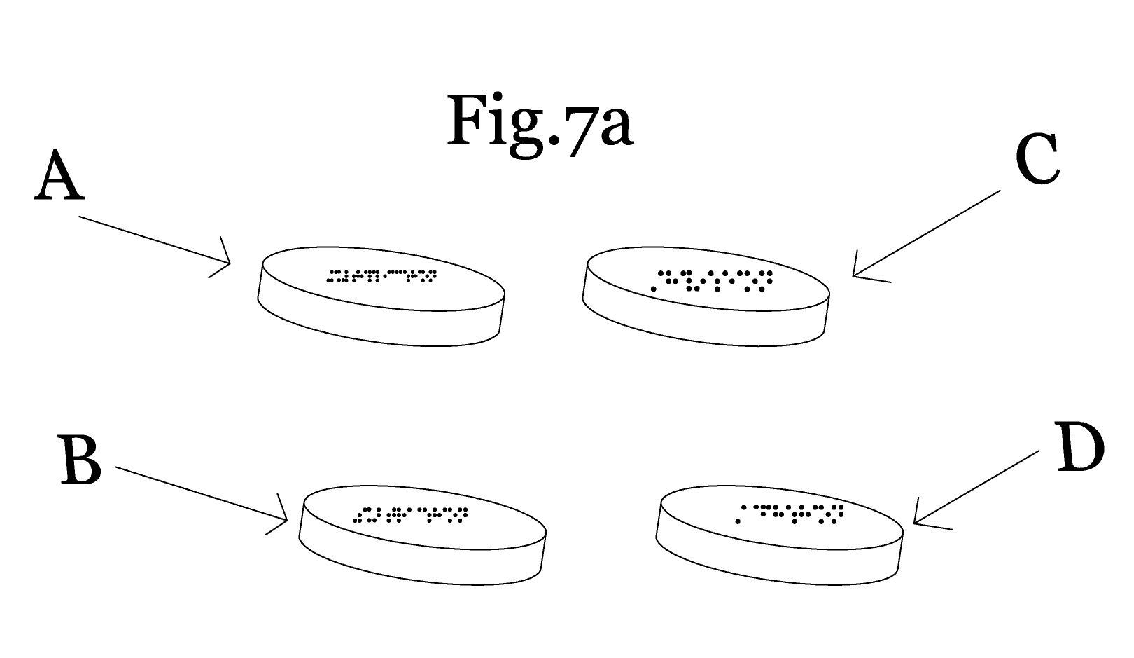

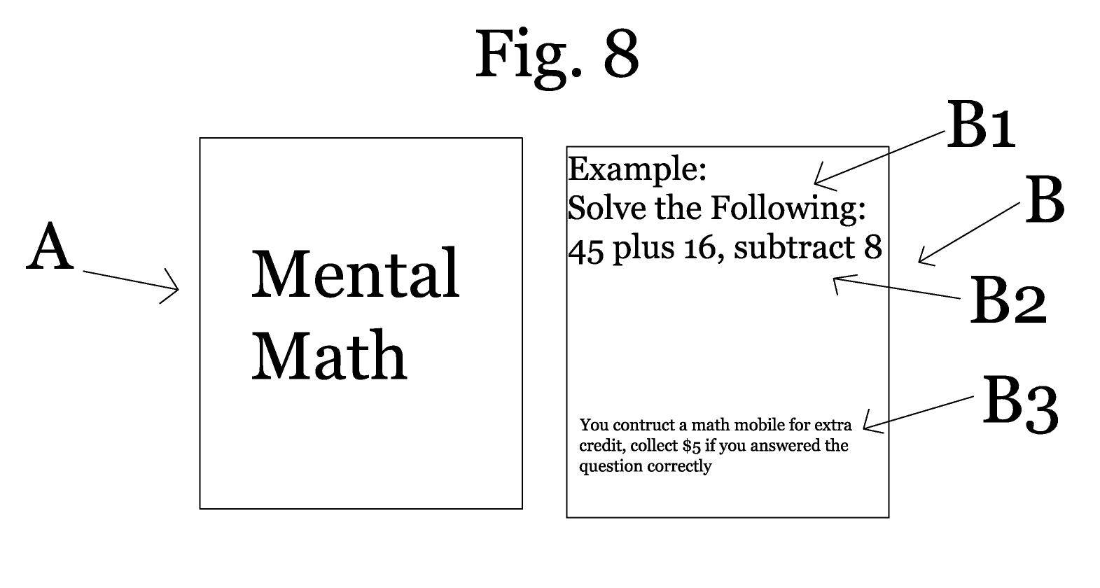

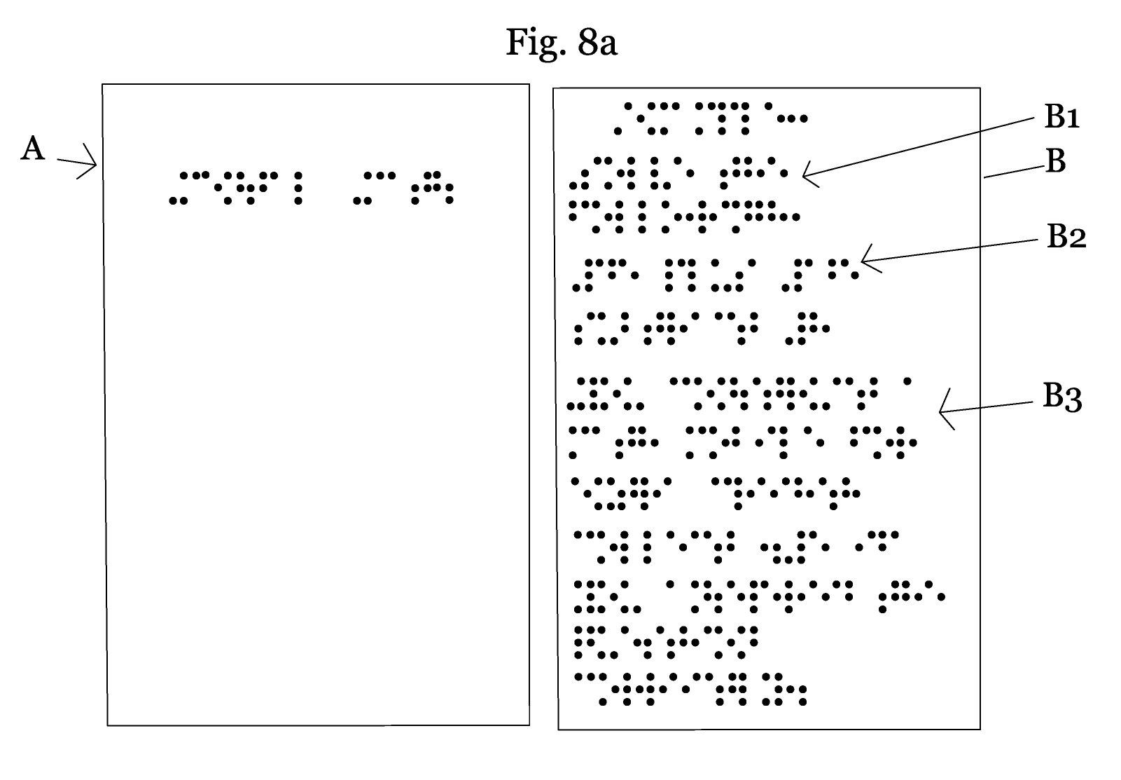

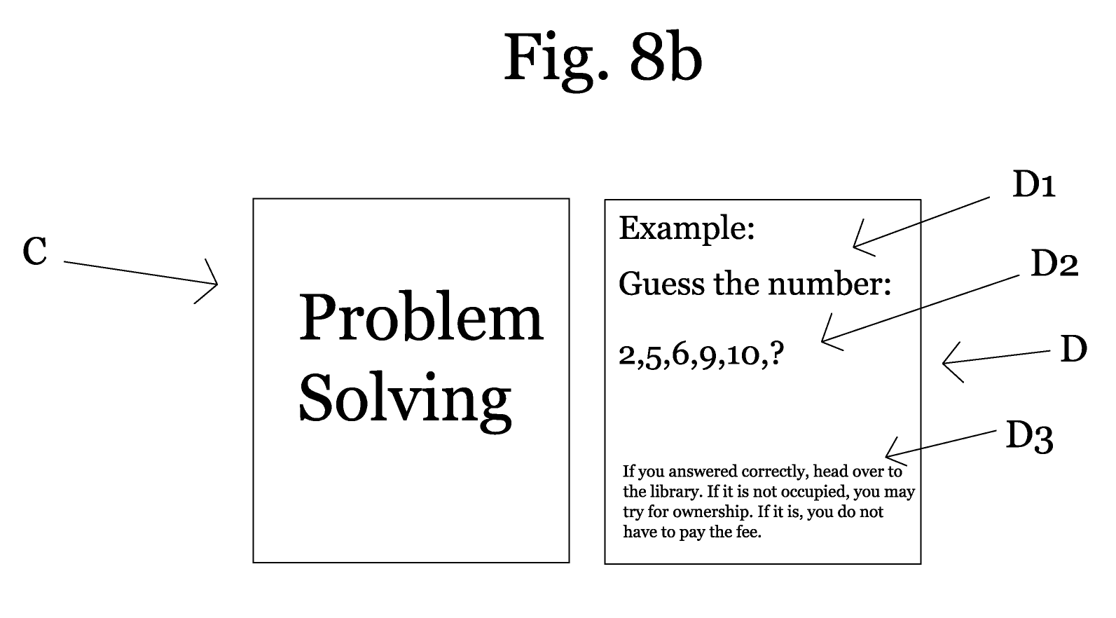

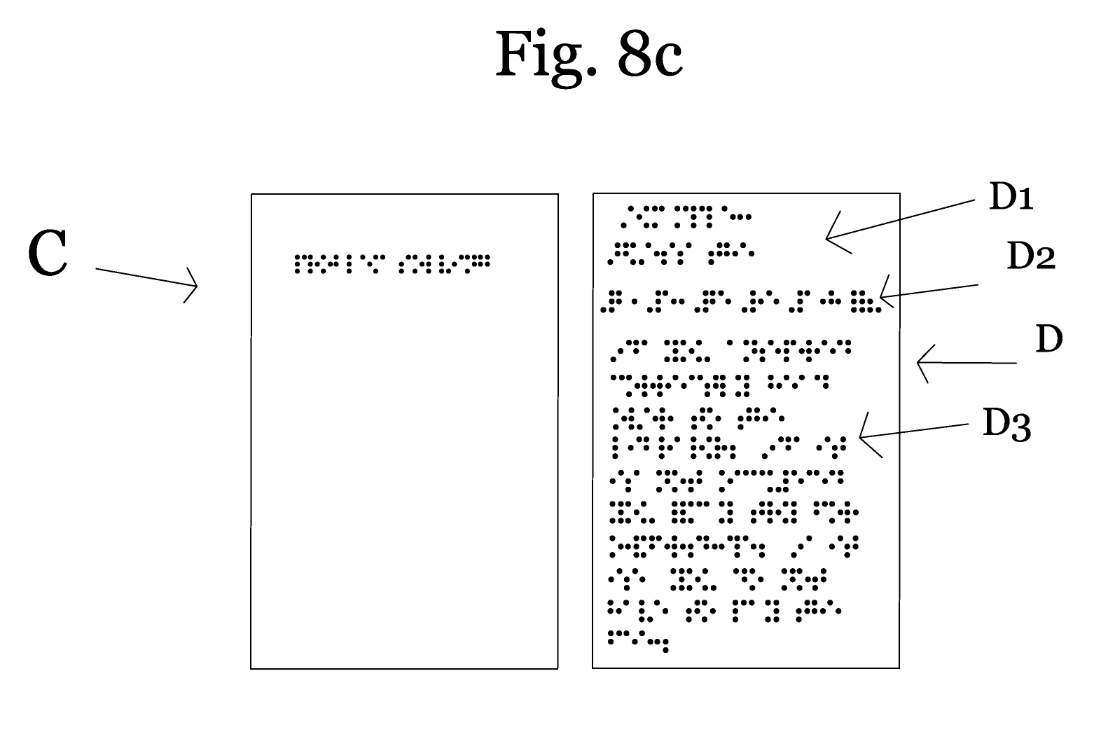

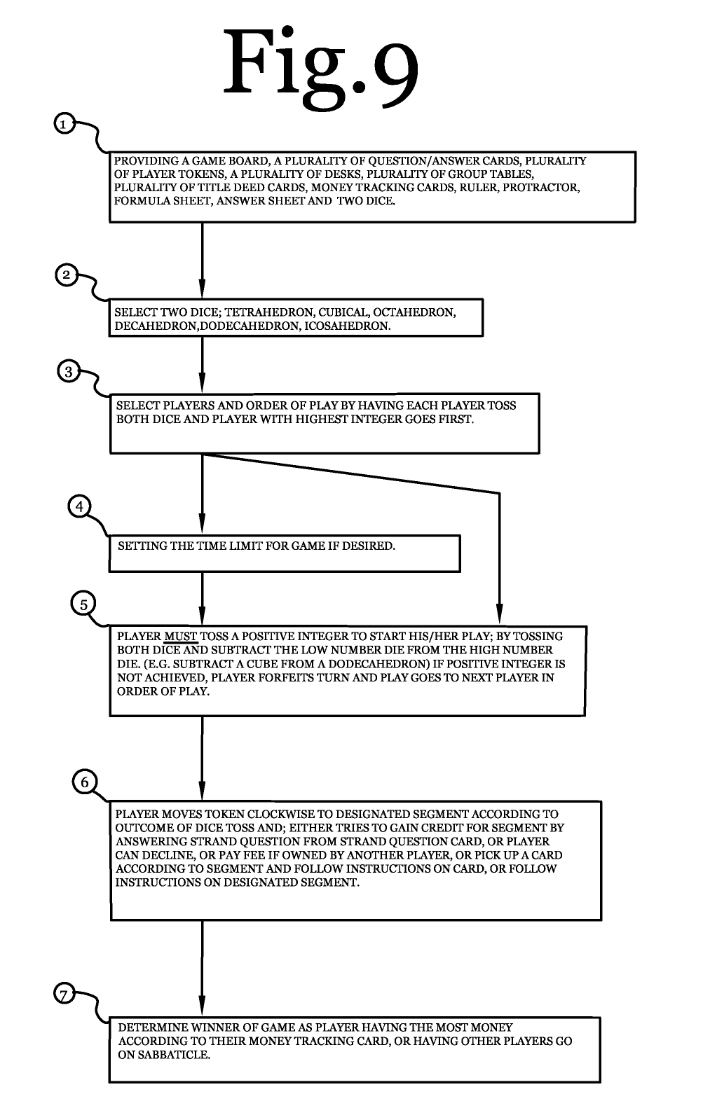

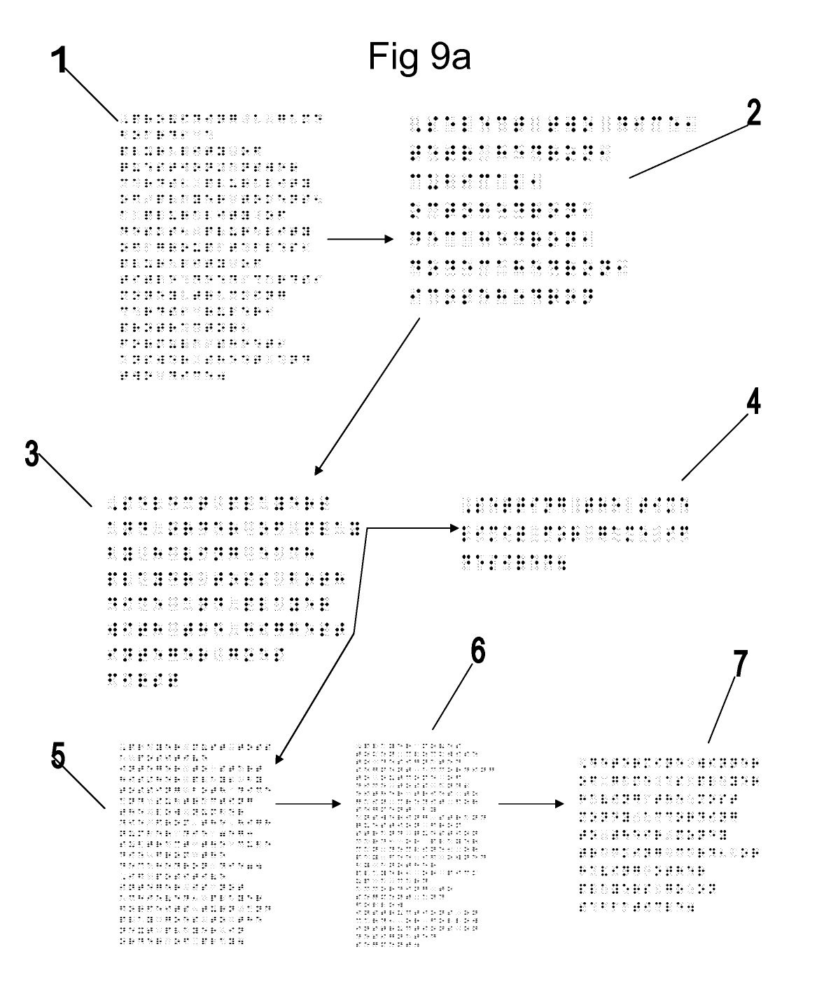

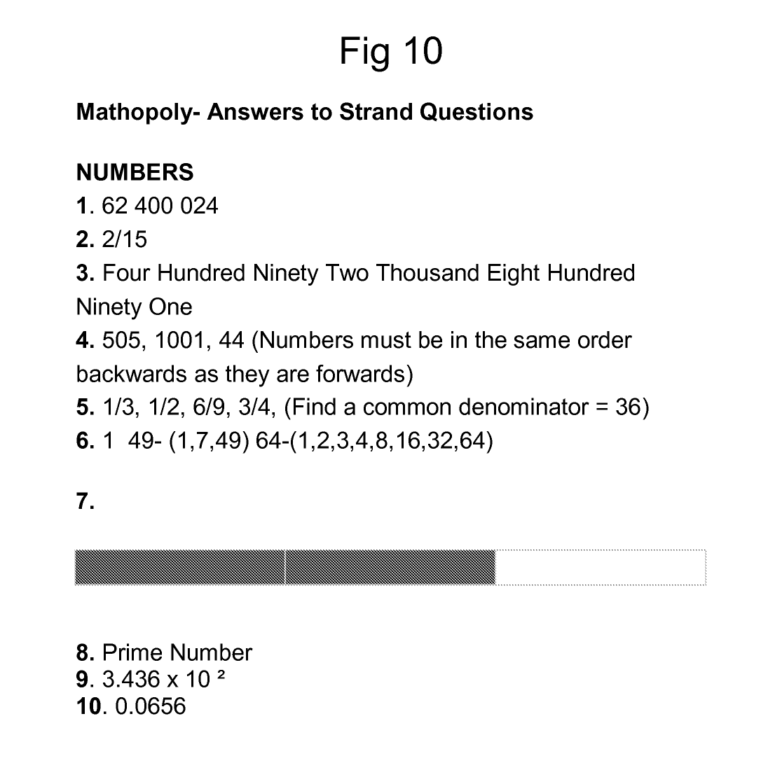

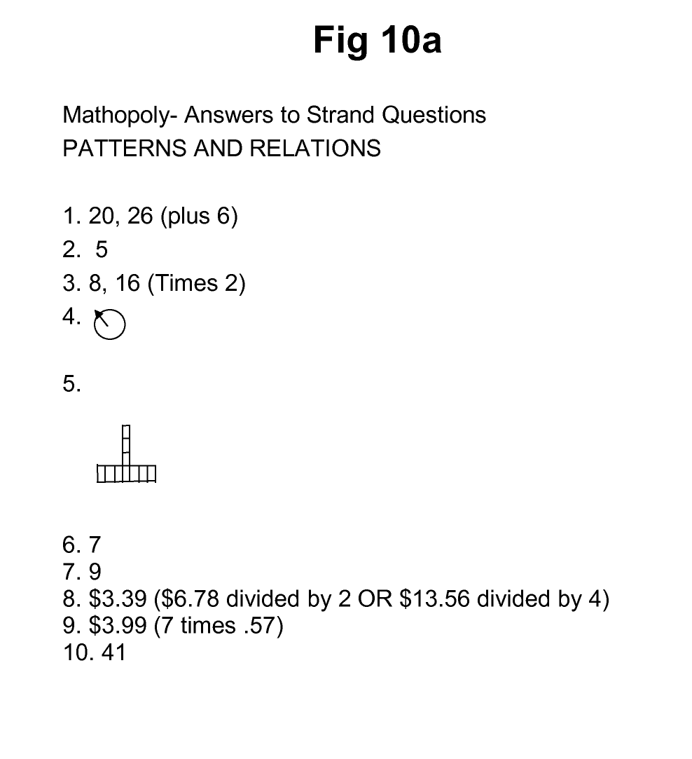

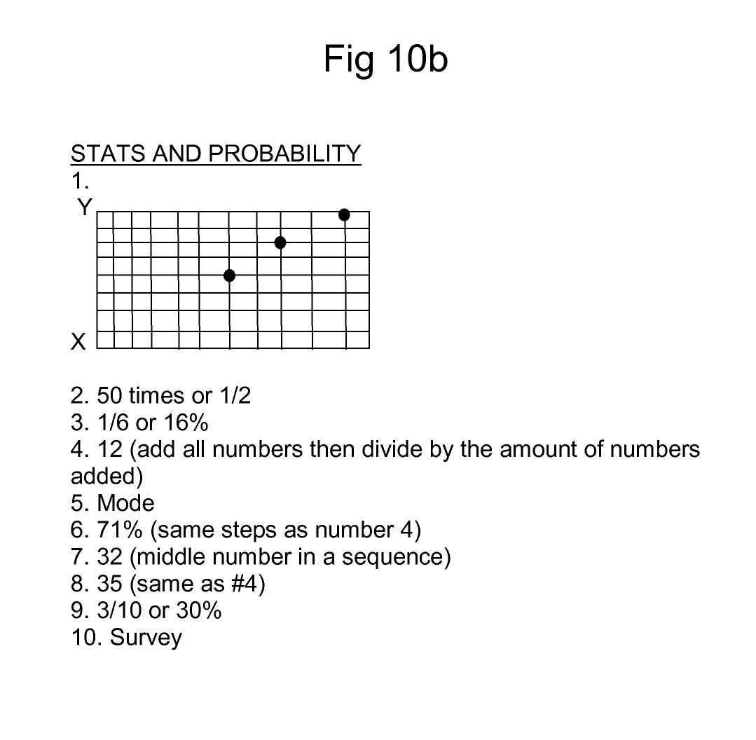

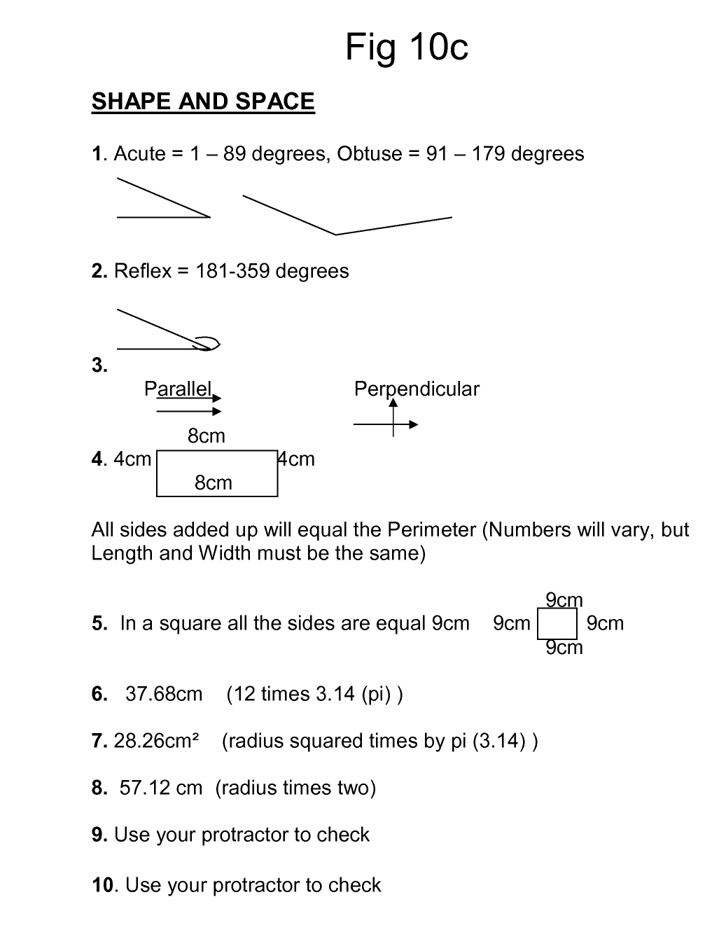

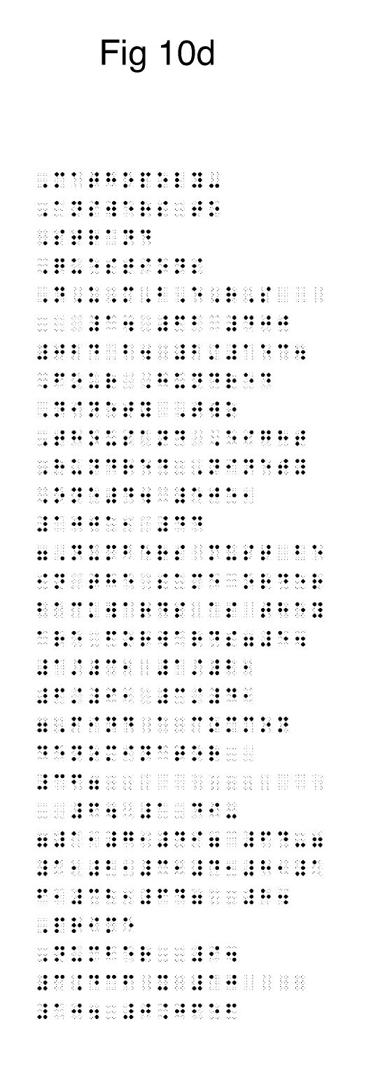

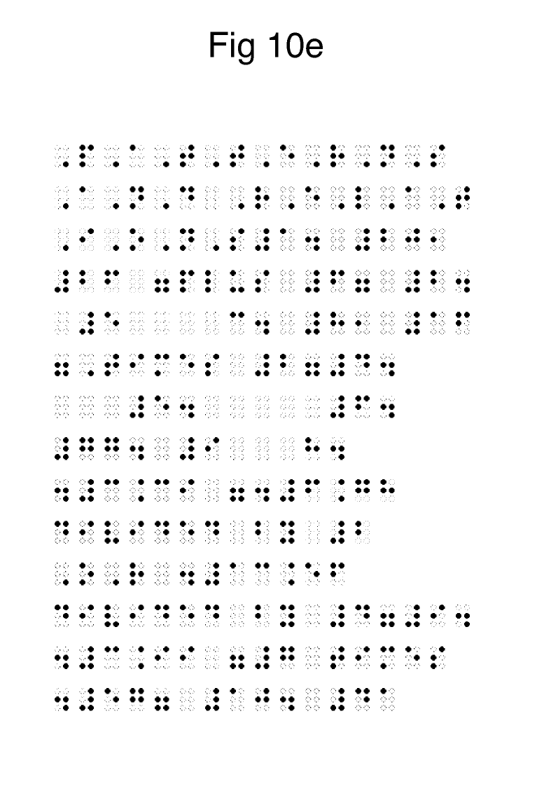

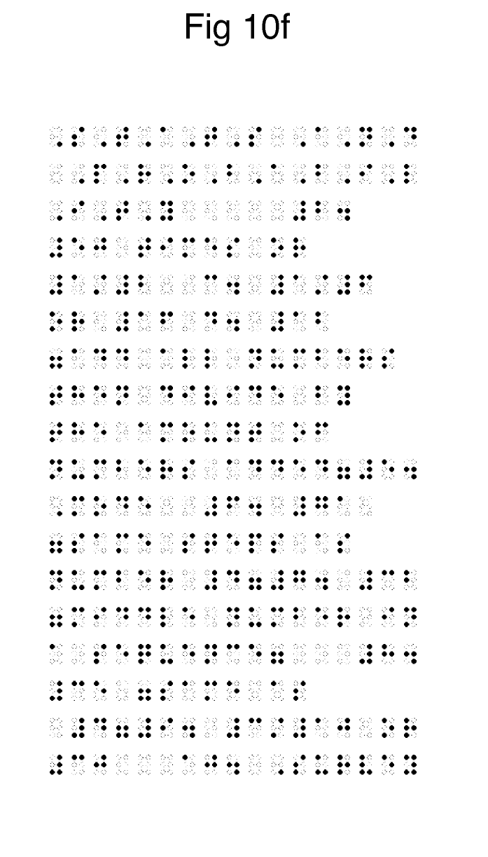

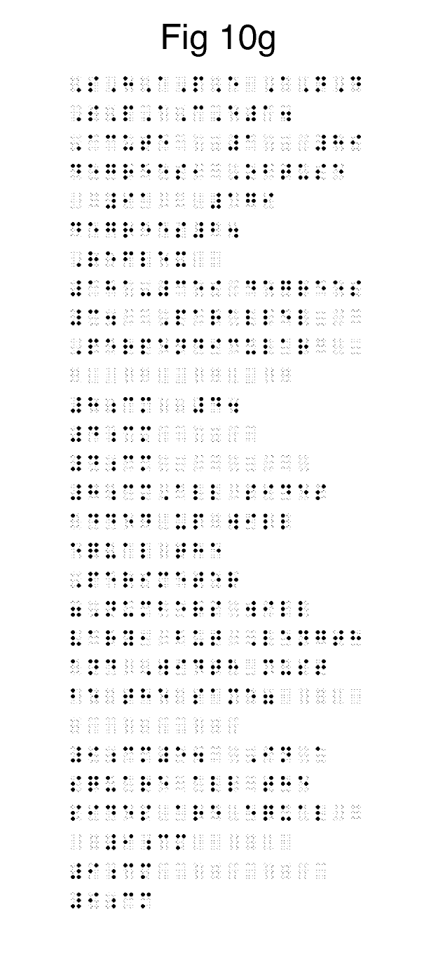

FIG. 3a provides a perspective view of a Line Graph (I) in Braille, player tokens (O) in Braille, Protractor (P) in Braille, Ruler (Q) in Braille, money tracking card (K) in Braille, Title deed card (L) in Braille, Group Table (M) in Braille, Desk (N) in Braille. The Line Graph (I) is to be referred to when a question is given pertaining to information needed in order to solve a graphing question. Player tokens (O) are assigned to individual players to be utilized for game play. The Protractor (P) is to be used when a question is given pertaining to angles in order to solve an angle question. The Ruler (Q) is to be used when a question is given pertaining to measurement in order to solve a measurement question. The Money Tracking card (K) is labeled with a predetermined amount of money which must be used by each individual player for calculating transactions incurred during game play. The Title deed card (L) is to be given to players that have ownership of a designated segment(S) and used for reference for fees owed by other players that have his/her token (O) positioned on the designated segment.

The Group table (M) may be purchased during players turn to take the place of four (4) desks (N) and to be placed on designated segments. The Desk(s) (N) may be purchased during players turn when a completed mathematical unit has been earned and may be purchased individually to a maximum of four (4).

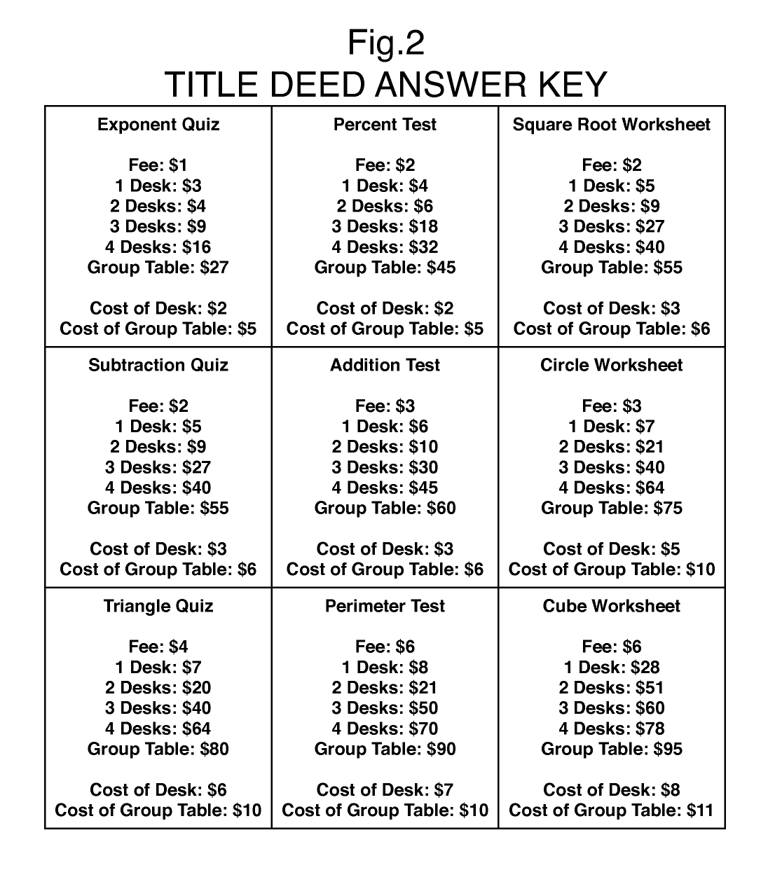

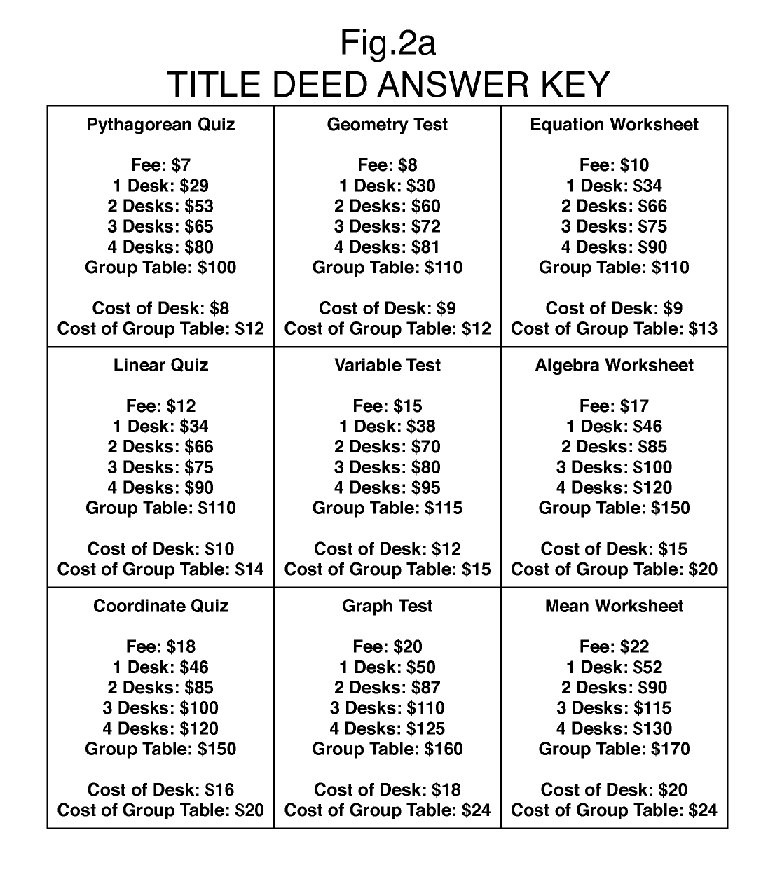

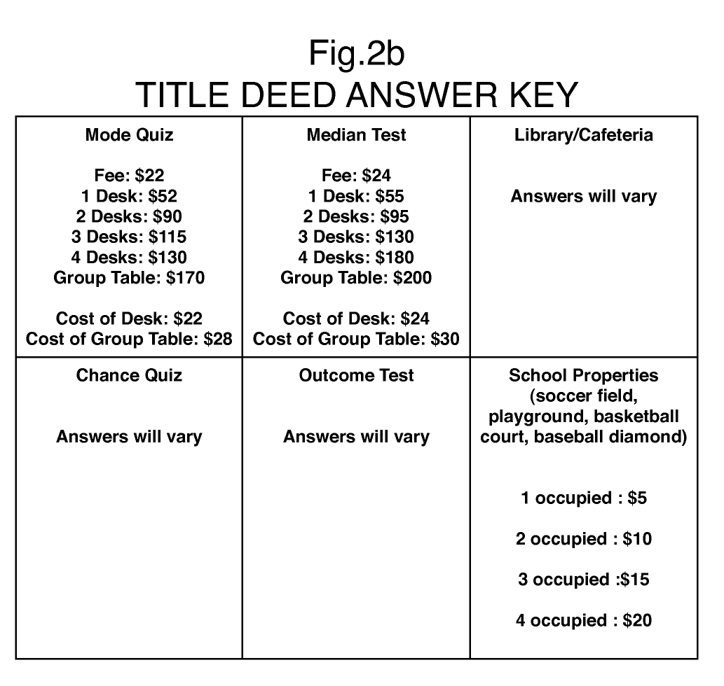

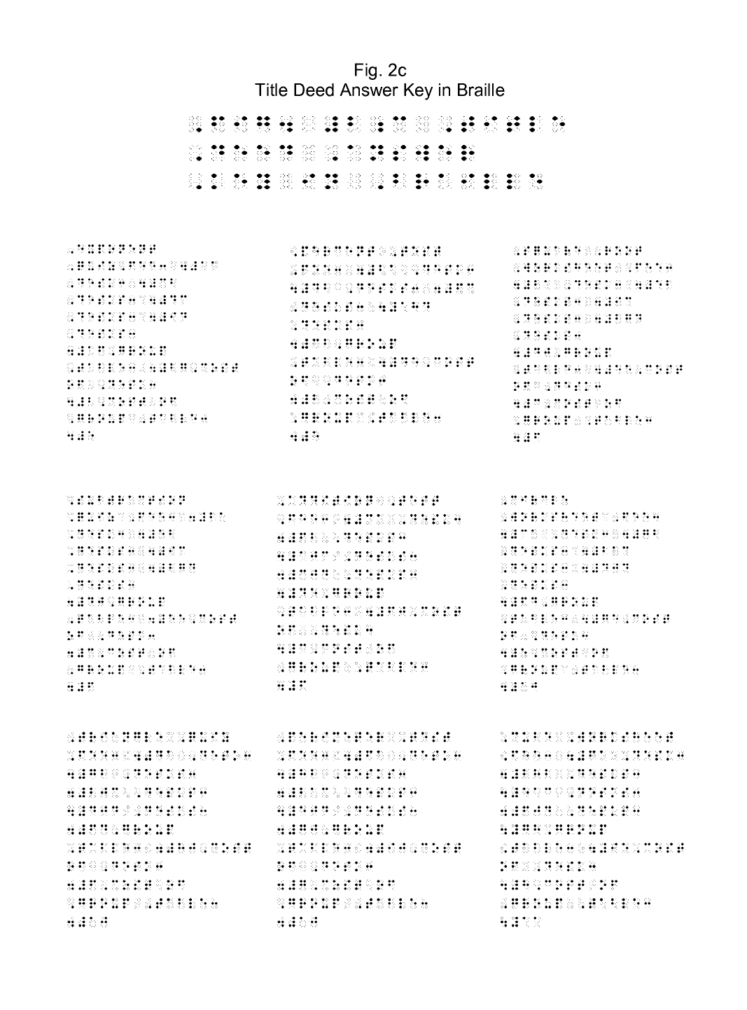

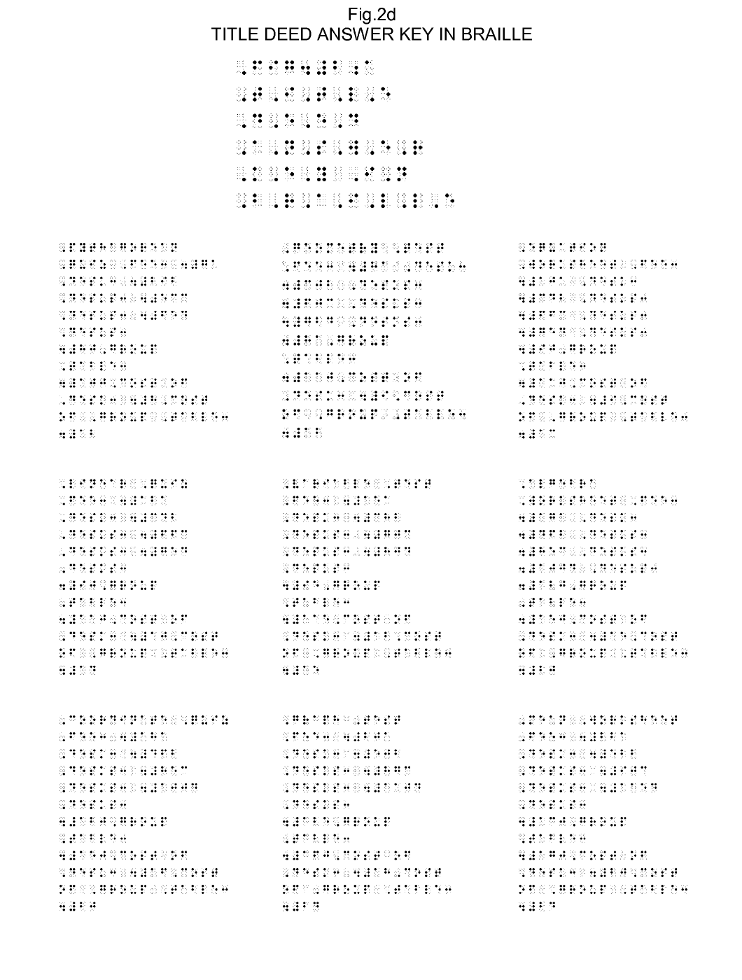

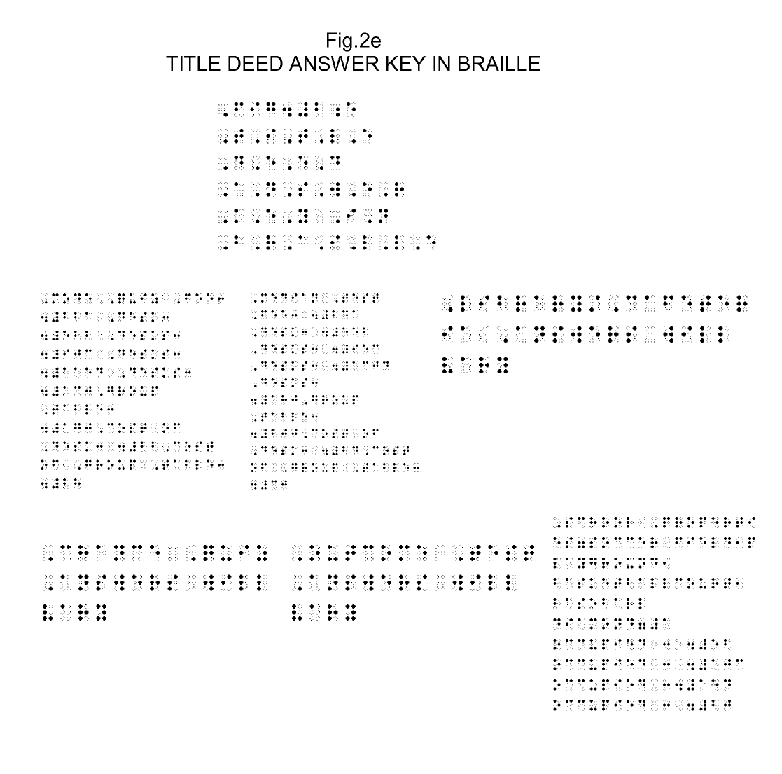

FIG. 4 provides a perspective view of Strand Question cards. The Patterns and Relations card(s) front may have insignia/indicia (insignia shown) on front of card (A1) and question related to the particular strand on rear of card (B1), with an equation (if applicable) (C1), and the reference number (D1) to Answers to Strand Questions sheet (FIG. 2a). The Numbers card(s) front may have insignia/indicia (insignia shown) on front of card (A2) and question related to the particular strand on rear of card (B2), with an equation (if applicable) (C2), and the reference number (D2) to Answers to Strand Questions sheet (FIG. 2a). The Shape and Space card(s) front may have insignia/indicia (insignia shown) on front of card (A3) and question related to the particular strand on rear of card (B3), with an equation (if applicable) (C3), and the reference number (D3) to Answers to Strand Questions sheet (FIG. 2a). The Statistics and Probability card(s) front may have insignia/indicia (insignia shown) on front of card (A4) and question related to the particular strand on rear of card (B4), with an equation (if applicable) (C4), and the reference number (D4) to Answers to Strand Questions sheet (FIG. 2a).

FIG. 4a provides a perspective view of Strand Question cards in Braille. The Patterns and Relations card(s) front may have insignia/indicia (insignia shown) on front of card (A1) and question related to the particular strand on rear of card (B1), with an equation (if applicable) (C1), and the reference number (D1) to Answers to Strand Questions sheet (FIG. 2a). The Numbers card(s) front may have insignia/indicia (insignia shown) on front of card (A2) and question related to the particular strand on rear of card (B2), with an equation (if applicable) (C2), and the reference number (D2) to Answers to Strand Questions sheet (FIG. 2a). The Shape and Space card(s) front may have insignia/indicia (insignia shown) on front of card (A3) and question related to the particular strand on rear of card (B3), with an equation (if applicable) (C3), and the reference number (D3) to Answers to Strand Questions sheet (FIG. 2a). The Statistics and Probability card(s) front may have insignia/indicia (insignia shown) on front of card (A4) and question related to the particular strand on rear of card (B4), with an equation (if applicable) (C4), and the reference number (D4) to Answers to Strand Questions sheet (FIG. 2a).

FIG. 5 provides a perspective view of a Title deed card front (A) with Insignia shown, but may include Insignia, Indicia or both. The rear of Title deed card (B) has a Segment Title (C), Initial fee (D) (if owned and free of desks (N) and group table) according to equation, Fee(s) (E) (if owned with either desk(s) or group table according to equation(s) and purchasing fee (F) for individual desk and/or group table.

FIG. 5a provides a perspective view of a Braille Title deed card front (A) in with Insignia shown, but may include Insignia, Indicia or both. The rear of Title deed card (B) also in Braille has a Segment Title (C), Initial fee (D) (if owned and free of desks (N) and group table) according to equation, Fee(S) (E) (if owned with either desk(S) or group table according to equation (S) and purchasing fee (F) for individual desk and/or group table.

FIG. 6 provides a perspective view of dice that may be used in combination of two (2) different dice during course of play on game board or two Braille dice. The dice include a Tetrahedron, Cube, Octahedron, Decahedron, Dodecahedron, Icosahedron and a Braille cube die.

FIG. 7 provides a perspective view of player tokens that may be used in the course of play on game board. The tokens include Multiplication (A) (indicia and insignia shown), Subtraction (B) (indicia and insignia shown), Division (C) (indicia and insignia shown) and Addition (D) (indicia and insignia shown).

FIG. 7a provides a perspective view of player tokens in Braille that may be used in the course of play on game board. The tokens include Multiplication (A), Subtraction (B), Division (C) and Addition (D).

FIG. 8 provides a perspective view of Mental Math question card front (A) (with indicia shown) and Mental Math question card rear (B) (with indicia shown). The rear of card (B) also includes question (B1), equation (B2) and compensation (B3) if answered correctly.

FIG. 8a provides a perspective view of a Braille Mental Math question card front (A) and Mental Math question card rear (B). The rear of card (B) also includes question (B1), equation (B2) and compensation (B3) if answered correctly.

FIG. 8b provides a perspective view of Problem Solving question card front (C) (with indicia shown) and Problem Solving question card rear (D) (with indicia shown). The rear of card (D) also includes question (D1), equation (D2) and compensation (D3) if answered correctly.

FIG. 8c provides a perspective view of a Braille Problem Solving question card front (C) and Problem Solving question card rear (D). The rear of card (D) also includes question (D1), equation (D2) and compensation (D3) if answered correctly.

FIG. 9 is a flow chart showing its various steps and at least one method of playing the present game.

FIG. 9a is a Braille flow chart showing its various steps and at least one method of playing the present game.

FIGS. 10, 10a, 10b & 10c provide a perspective view of the answer key to strand questions.

FIGS. 10d, 10e, 10f & 10g provides a perspective view of the answer key to strand questions in Braille.

### DETAILED DESCRIPTION

The present invention comprises a means of playing an educational math game, wherein players utilize two different valued dice to generate a random integer and move a token clockwise along peripheral path to a designated segment. When player token is positioned on designated segment that requires a strand question card, player has the option of gaining credit for segment by correctly answering a strand question from the strand question card designated to that particular segment and paying a fee on the designated segment, if player answers correctly, player gains credit for designated segment and receives that segments title deed card (L) as shown in FIG. 3 to keep in his/her possession and may sell the title deed card (L) as shown in FIG. 3 to other players at a price agreed upon by both parties. If player answers incorrectly, player forfeits card back to designated card set and does not pay fee, or player can decline to answer question. Player must pay a determined fee according to the designated segment's title deed card (L) as shown in FIG. 3 if owned by another player. If players token is positioned on a segment that incurs an automatic fee to be paid (i.e. art fees, field trip) player must pay the fee designated to that particular segment. If players token is positioned on a designated segment with no fee incurred or title deed card (L) as shown in FIG. 3 to be earned, player picks up a card corresponding to designated segment and follow instructions on designated card.

If a player owns a mathematical unit which is comprised of a plurality of designated segments (i.e. percent test, exponent quiz) player has option to purchase desk(s) (price of desk(s) are predetermined on title deed card (L) as shown in FIG. 3 as shown in FIG. 3 which consists of a mathematical equation) to further increase fee owing if other players token is positioned on segment). Players may purchase up to three (3) additional desks (N) as shown in FIG. 3 per segment when its player turn again. If a player's token is positioned on an owned segment, player will pay a predetermined fee according to title deed card (L) as shown in FIG. 3 which consists of a mathematical equation which determines the fee incurred.

Group tables (M) as shown in FIG. 3 may be purchased when all segments in a designated unit have the maximum amount of desks (N) as shown in FIG. 3 (4) per segment thereon. Desks (N) as shown in FIG. 3 must be removed when a group table is positioned on designated segment.

Fee to purchase group table is predetermined according to title deed card (L) as shown in FIG. 3 which consists of a mathematical equation. Fee incurred when other players token is positioned on designated segment with group table is predetermined according to title deed card (L) as shown in FIG. 3 which consists of a mathematical equation.

The object of the game is to earn the most amount of money or having other players leave the game by way of sabbatical.

Sabbatical is determined by players unable to pay fees or cannot retain title deed card (L) as shown in FIG. 3. Without title deed card (L) as shown in FIG. 3 as shown in FIG. 3, players cannot collect fees. A timer may be used in the course of play to determine the winner and duration of play and the player with the most money wins the game.

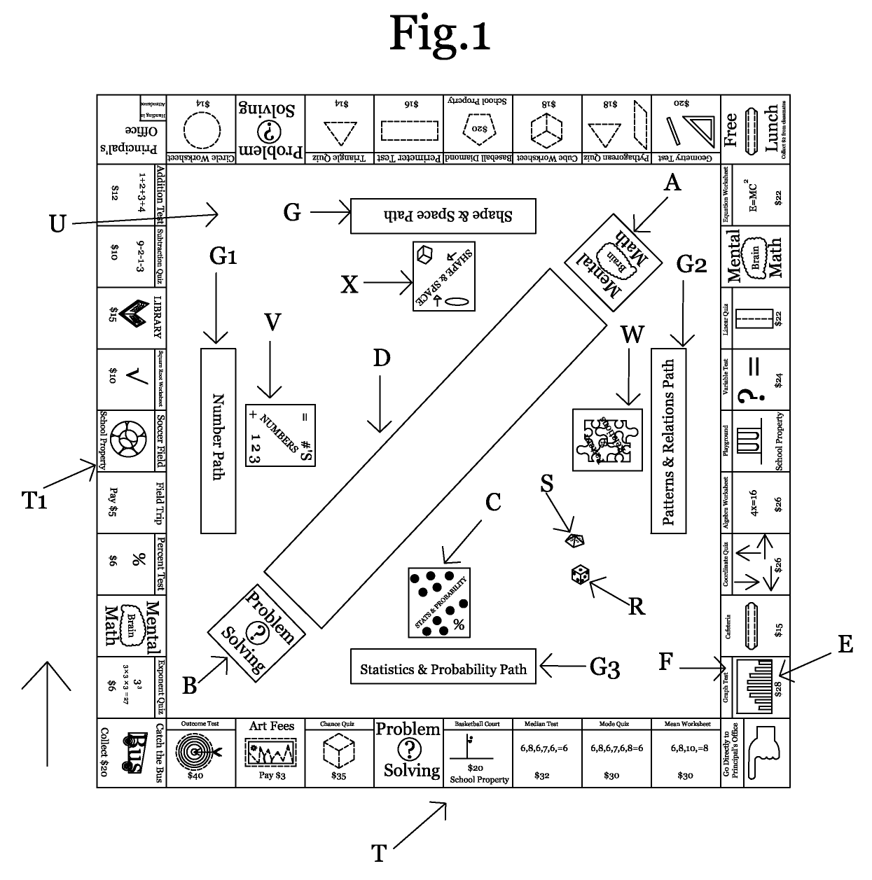

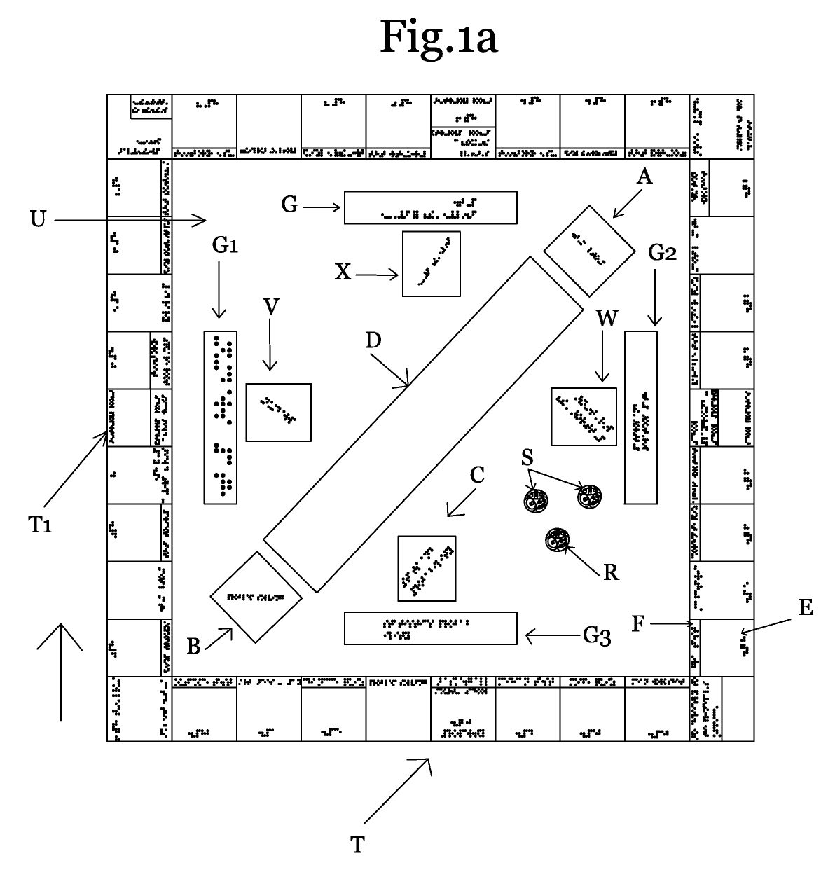

FIG. 1 provides a perspective view of a first embodiment of a board game, which may be used for play in the present game. The board (T) includes a peripheral path (T1), a plurality of segments (E) and a plurality of inner segments (F) surrounding a surface (U) for tossing dice thereupon. (Example cubical die (R) and decahedron die (S) to generate random integers.) Each of the segments (E) and inner segments (F) are positioned on a continuous path along outer perimeter of board game. The board game further includes a plurality of Mental Math cards (A), a plurality of Problem Solving cards (B), a plurality of Statistics and Probability cards (C), a plurality of Numbers cards (V), a plurality of Pattern and Relation cards (W), a plurality of Shape and Space cards (X), Shape and Space Path (G), Number Path (G1), Pattern and Relation Path (G2), Statistics and Probability Path (G3) and a location for board game name/logo (D).

The present game may be played between two or more players by selecting a means of play by; having all players agree upon either/or a time limit, maximum currency needed to win the game, most completed units, sending other players into sabbatical, subtracting the low value die from high value die or a high value die from the low value die resulting in a positive or negative integers.

Each player tosses the dice to determine order of play by; tossing the dice and subtracting the number on the lowest sided die from the number on the highest sided die (e.g. cube value=2 from tetrahedron value=4 for a difference of 2 or cube value=6 from tetrahedron value=3 for a difference of −3). The player with the highest positive value integer will start the game and all other players play in a clockwise rotation. All players then choose a token shown in FIG. 3 of their choice to represent them during game play.

Play is accomplished by; tossing a high valued die (S) and a low valued die (R) upon the playing surface (U) on the board game (T). Player moves token shown in FIG. 3 along peripheral path to a designated segment (E) according to the result of dice toss. When players token shown in FIG. 3 is positioned on a designated segment (E) as per dice toss (R and S), he/she has the option of; A) attaining the credit by correctly answering the corresponding strand question (V, C, X or W) and if answered correctly the player attains the title deed card (L) as shown in FIG. 5 for that segment or bypassing the option to attain credit or paying the fee (a fee derives from a title deed card (L) as shown in FIG. 5 for positioning token shown in FIG. 3 on a segment (E) that has previously been attained from a player; or B) picking up a card as shown in FIGS. 8 & 8a and following instructions as shown in FIGS. 8 B3 & 8a D3 on the card; or C) positioning token shown in FIG. 3 on a segment (E) and follow the instructions on that particular segment. The next player in the order of play plays the same game as the previous player. The game ends and a winner is determined by; a) time limit has expired, b) maximum currency attained c) most completed units or d) sending other players into sabbatical.

As an example of the above as shown in FIG. 1, let us assume that the method of play agreed amongst players is to achieve maximum currency.

The game is played by placing the game board (T) on a playing surface with the Mental Math (A), Problem Solving (B), Statistic and Probability (C), Patterns and Relation cards (W), Numbers Cards (V) and Shape and Space Cards (X) face down on their allotted designated area on the game board (T). A secretary is chosen amongst player's to watch over the money being exchanged and also to clarify the rules to other players if there is a discrepancy. Each player chooses one token shown in FIG. 3 and will receive a $250 money tracking card (K) shown in FIG. 3. This card will help the player to keep track of money paid for segments or for incoming money paid by other players or any other monetary gain.

Starting with the player to the right of the secretary, each player takes a turn tossing both dice (S, R) to determine order of play. The player with the highest positive integer goes first. (EG—Six sided die subtracted from the ten sided die) All players must toss a positive integer to start game play. If a player can't toss a positive integer when it is their turn, they may try again after all players have had their turn.

All players position their token shown in FIG. 3 on the designated segment “Catch the bus”. First player then tosses both dice (R, S) and then moves his/her token shown in FIG. 3 according to the difference of the dice toss. Player must have a positive integer to start the game and moves clockwise from the “Catch the bus” segment. If a player achieves a negative integer on their first dice toss, their turn is over and play goes to the next player in order of play and continues playing the same method as the previous player.

If the players dice toss results in positioning his/her token shown in FIG. 3 on the “Exponent Quiz” segment, the player then would have the opportunity to gain credit for that segment and can now accept or decline that opportunity. If the player accepts the opportunity he/she would choose the top card of the “number path” strand card set (V). The card would ask the player a question within that strand (G1).

The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet as shown in FIGS. 10, 10a, 10b and 10c. If it has been determined that the answer given is correct, the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

If the player has answered the question incorrectly, play then goes to the next player with the previous player not gaining credit for that segment and leaving the segment available. All strand cards (C, V, W, X) regardless if answered correctly or incorrectly are put on the bottom of the strand card set.

As play continues and the players dice toss results in positioning his/her token shown in FIG. 3 on the “Mental Math” segment they will have to pick up the top card from the Mental Math card set (A) and read it aloud to the other players. (EG—If the card reads What is greater? 7−3 or 9−6?) The player answers 7−3 which results in a four whereas 9−6 only results in a three. The players must agree that this is correct. Once that is determined, the player reads the bottom of the card which states “You sold the most chocolate bars for the school fundraiser, collect $10 if you were correct.” The player then adds $10 to their money tracking card (K) shown in FIG. 3 due to the correct answer given.

As play continues and the players dice toss results in positioning his/her token shown in FIG. 3 on the “Percent Test” segment, the player then would have the opportunity to gain credit for that segment and can now accept or decline that opportunity. If the player accepts the opportunity he/she would choose the top card of the “number path” strand card set (V).

The card would ask the player a question within that strand (G1). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct, the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Field Trip” segment. This segment carries with it a fee to be subtracted from the player's money tracking card (K). It is a non-negotiable fee which is clearly stated on the designated segment.

As play continues and the players dice toss results in positioning his/her token shown in FIG. 3 on the “Soccer Field” segment, the player then would have the opportunity to gain credit for that segment and can now accept or decline that opportunity. If the player accepts the opportunity he/she would choose the top card of the “number path” strand card set (V). The card would ask the player a question within that strand (G1).

The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c.

If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Square Root Work Sheet” segment, the player then would have the opportunity to gain credit for that segment and can now accept or decline that opportunity. If the player accepts the opportunity he/she would choose the top card of the “number path” strand card set (V). The card would ask the player a question within that strand (G1). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Library” segment, the player then would have the opportunity to gain credit for that segment and can now accept or decline that opportunity. If the player accepts the opportunity he/she would choose the top card of the “number path” strand card set (V). The card would ask the player a question within that strand (G1). The player will read the card out loud to the other players and then will try and answer the given question. The player may use scrap paper to try and figure out the answer if needed.

Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token on the “Subtraction Quiz” segment, the player then would have the opportunity to gain credit for that segment and can now accept or decline that opportunity. If the player accepts the opportunity he/she would choose the top card of the “number path” strand card set (V). The card would ask the player a question within that strand (G1). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Addition Test” segment, the player then would have the opportunity to gain credit for that segment and can now accept or decline that opportunity. If the player accepts the opportunity he/she would choose the top card of the “number path” strand card set (V). The card would ask the player a question within that strand (G1).

The player will read the card out loud to the other players and then will try and answer the given question. The player may use scrap paper to try and figure out the answer if needed.

Once an answer is given, the rest of the players may challenge the answer if they feel it may be incorrect and the secretary can check the provided answer on the strand questions answer sheet shown in FIGS. 10, 10a, 10b and 10c If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the segment entitled “Principals Office” because of their roll, they would not incur a penalty for landing on the segment because they are handing in attendance which is a designated segment within that segment. When a players token shown in FIG. 3 lands on the Principals Office they cannot attain this segment through a question because it has no value and therefore unattainable.

As play continues and the players dice toss results in positioning his/her token shown in FIG. 3 on the “Circle Work Sheet” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c.

If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the segment entitled “Problem Solving”. It is on this segment that they will have to pick up the top card from the problem solving pile of cards (B). (EG—If the card reads “You have won first place at the Art fair. This card entitles you to not pay for your next art supplies fee when and if you land on that segment.” The player then keeps the card for possible future use.)

As play continues and the players dice toss results in positioning his/her token shown in FIG. 3 on the “Triangle Quiz” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Perimeter Test” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Baseball Diamond” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Cube Work Sheet” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Pythagorean Quiz” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c.

If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Geometry Test” segment, the player then would have the opportunity to gain credit for that segment and can now accept or decline that opportunity. If the player accepts the opportunity he/she would choose the top card of the “Shape & Space” strand card sets (X). The card would ask the player a question within that strand (G). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Free Lunch” segment, the player rolls a positive integer of six on their next roll. They have landed on the segment entitled “Free Lunch”. The segment states that the player will collect $2 from each of the other players that are involved in the game. This money is to be added to their money tracking card (K) shown in FIG. 3 and the players who have given the $2 to that player will now subtract $2 from their money tracking card (K) shown in FIG. 3. There is no question to be answered for the fee and this segment is not attainable through a question correctly answered.

As play continues and the players dice toss results in positioning his/her token shown in FIG. 3 on the “Equation Work Sheet” segment, the player then would have the opportunity to gain credit for that segment and can now accept or decline that opportunity. If the player accepts the opportunity he/she would choose the top card of the “Pattern & Relation” strand cards (W). The card would ask the player a question within that strand (G2).

The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Linear Quiz” segment, the player then would have the opportunity to gain credit for that segment and can now accept or decline that opportunity. If the player accepts the opportunity he/she would choose the top card of the “Pattern & Relation” strand card sets (W). The card would ask the player a question within that strand (G2). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Variable Test” segment, the player then would have the opportunity to gain credit for that segment and can now accept or decline that opportunity.

If the player accepts the opportunity he/she would choose the top card of the “Pattern & Relation” strand card sets (W). The card would ask the player a question within that strand (G2). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “School Playground” segment, the player then would have the opportunity to gain credit for that segment and can now accept or decline that opportunity. If the player accepts the opportunity he/she would choose the top card of the “Pattern & Relation” strand card sets (W). The card would ask the player a question within that strand (G2). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Algebra Work Sheet” segment, the player then would have the opportunity to gain credit for that segment and can now accept or decline that opportunity. If the player accepts the opportunity he/she would choose the top card of the “Pattern & Relation” strand card sets (W). The card would ask the player a question within that strand (G2). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token on the “Coordinate Quiz” segment, the player then would have the opportunity to gain credit for that segment and can now accept or decline that opportunity. If the player accepts the opportunity he/she would choose the top card of the “Pattern & Relation” strand card sets (W). The card would ask the player a question within that strand (G2). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Graph Test” segment, the player then would have the opportunity to gain credit for that segment and can now accept or decline that opportunity. If the player accepts the opportunity he/she would choose the top card of the “Pattern & Relation” strand cards. The card would ask the player a question within that strand. The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the segment entitled “G0 directly to the Principals office”. The player then must move their token shown in FIG. 3 to the segment entitled “Principals Office”. The player then loses their turn, and must on three consecutive turns roll a positive integer before they can resume play. However the player can choose to buy their way out of the Principals office at anytime during their turn, the fee to leave the Principals Office is $50 to be subtracted from their money tracking card (K) shown in FIG. 3. Once the $50 is paid or three consecutive positive integers have been tossed the player continues to play starting from the “Handing in Attendance” space provided on the Principals Office segment.

As play continues and the players dice toss results in positioning his/her token shown in FIG. 3 on the “Mean Work Sheet” segment, the player then would have the opportunity to gain credit for that segment and can now accept or decline that opportunity.

If the player accepts the opportunity he/she would choose the top card of the “Statistic & Probability” strand card sets (C). The card would ask the player a question within that strand (G3). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet 760 shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Mode Quiz” segment, the player then would have the opportunity to gain credit for that segment and can now accept or decline that opportunity. If the player accepts the opportunity he/she would choose the top card of the “Statistic & Probability” strand card sets (C). The card would ask the player a question within that strand (G3). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Median Test” segment, the player then would have the opportunity to gain credit for that segment and can now accept or decline that opportunity. If the player accepts the opportunity he/she would choose the top card of the “Statistic & Probability” strand card sets (C). The card would ask the player a question within that strand (G3). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Basketball Court” segment, the player then would have the opportunity to gain credit for that segment and can now accept or decline that opportunity. If the player accepts the opportunity he/she would choose the top card of the “Statistic & Probability” strand card sets (C). The card would ask the player a question within that strand (G3). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c.

If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Chance Quiz” segment, the player then would have the opportunity to gain credit for that segment and can now accept or decline that opportunity. If the player accepts the opportunity he/she would choose the top card of the “Statistic & Probability” strand card sets (C). The card would ask the player a question within that strand (G3). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Art Fees” segment. This segment carries with it a fee to be subtracted from the players money tracking card (K) shown in FIG. 3. It is a non-negotiable fee which is clearly stated on the designated segment.

As play continues and the players dice toss results in positioning his/her token shown in FIG. 3 on the “Outcome Test” segment, the player then would have the opportunity to gain credit for that segment and can now accept or decline that opportunity.

If the player accepts the opportunity he/she would choose the top card of the “Statistic & Probability” strand card sets (C). The card would ask the player a question within that strand (G3). The player will read the card out loud to the other players and then will try and answer the given question. The player may use scrap paper to try and figure out the answer if needed. Once an answer is given, the rest of the players may challenge the answer if they feel it may be incorrect and the secretary can check the provided answer on the strand questions answer sheet shown in FIGS. 10, 10a, 10b and 10c. If it has been determined that the answer given is correct the player then receives the title deed card (L) shown in FIGS. 3 and 5 for that segment and has officially attained the credit for that segment and must pay the fee to attain the title deed card (L) shown in FIGS. 3 and 5 which is stated on the designated segment and then subtract that amount from their $250 money tracking card (K) shown in FIG. 3.

As play continues and the players dice toss results in positioning his/her token shown in FIG. 3 on the “Catch the Bus” segment, the segment clearly states that the player should collect $20, which is to be added to their money tracking card (K) shown in FIG. 3. (Only positive integers will be counted as passing over/on this segment to collect $20.00)

As play continues and the players dice toss results in a negative integer and therefore positioning his/her token shown in FIG. 3 on the “Catch the bus” segment, the player then would not have the opportunity to collect $20.00 for that segment.

As play continues and the players dice toss results in a negative integer and therefore positioning his/her token shown in FIG. 3 on the “Outcome Test” segment, the player then would not have the opportunity to gain credit for that segment.

As play continues and the players dice toss results in a negative integer and therefore positioning his/her token shown in FIG. 3 on the “Art Fees” segment, the player then must pay the art fee that is stated on the segment.

As play continues and the players dice toss results in a negative integer and therefore positioning his/her token shown in FIG. 3 on the “Chance Quiz” segment, the player then would not have the opportunity to gain credit for that segment.

As play continues and the players dice toss results in a negative integer and therefore positioning his/her token shown in FIG. 3 on the “Problem Solving” segment, the player then will have to pick up the top card from the problem solving pile of cards. (EG—If the card reads “You have won first place at the Art fair. This card entitles you to not pay for your next art supplies fee when and if you land on that segment.” The player then keeps the card for possible future use.)

As play continues and the players dice toss results in a negative integer and therefore positioning his/her token shown in FIG. 3 on the “Basket Ball Court” segment, the player then would not have the opportunity to gain credit for that segment.

As play continues and the players dice toss results in a negative integer and therefore positioning his/her token shown in FIG. 3 on the “Median Test” segment, the player then would not have the opportunity to gain credit for that segment.

As play continues and the players dice toss results in a negative integer and therefore positioning his/her token shown in FIG. 3 on the “Mode Quiz” segment, the player then would not have the opportunity to gain credit for that segment.

As play continues and the players dice toss results in a negative integer and therefore positioning his/her token shown in FIG. 3 on the “Mean Worksheet” segment, the player then would not have the opportunity to gain credit for that segment.

As play continues and the players dice toss results in a negative integer and therefore positioning his/her token shown in FIG. 3 on the “G0 directly to the principal's office” segment, the player then must move their token shown in FIG. 3 to the segment entitled “Principals Office”.

The player then loses their turn, and must on three consecutive turns roll a positive integer before they can resume play. However the player can choose to buy their way out of the Principals office at anytime during their turn, the fee to leave the Principals Office is $50 to be subtracted from their money tracking card (K) shown in FIG. 3. Once the $50 is paid or three consecutive positive integers have been tossed the player continues to play starting from the “Handing in Attendance” space provided on the Principals Office segment.

As play continues and the players dice toss results in a negative integer and therefore positioning his/her token shown in FIG. 3 on the “Graph Test” segment, the player then would not have the opportunity to gain credit for that segment.

As play continues and the players dice toss results in a negative integer and therefore positioning his/her token shown in FIG. 3 on the “Cafeteria” segment, the player then would not have the opportunity to gain credit for that segment.

As play continues and the players dice toss results in a negative integer and therefore positioning his/her token shown in FIG. 3 on the “Coordinate Quiz” segment, the player then would not have the opportunity to gain credit for that segment.

As play continues and the players dice toss results in a negative integer and therefore positioning his/her token shown in FIG. 3 on the “Algebra Worksheet” segment, the player then would not have the opportunity to gain credit for that segment.

As play continues and the players dice toss results in a negative integer and therefore positioning his/her token shown in FIG. 3 on the “School Playground” segment, the player then would not have the opportunity to gain credit for that segment.

As play continues and the players dice toss results in a negative integer and therefore positioning his/her token shown in FIG. 3 on the “Variable Test” segment, the player then would not have the opportunity to gain credit for that segment.

As play continues and the players dice toss results in a negative integer and therefore positioning his/her token shown in FIG. 3 on the “Linear Quiz” segment, the player then would not have the opportunity to gain credit for that segment.

As play continues and the players dice toss results in a negative integer and therefore positioning his/her token shown in FIG. 3 on the “Mental Math” segment, the player then will have to pick up the top card from the Mental Math card set (A) and read it aloud to the other players. (EG—If the card reads” What is greater? 7−3 or 9−6? The player answers 7−3 which results in a four whereas 9−6 only results in a three. The players must agree that this is correct. Once that is determined the player reads the bottom of the card which states “You sold the most chocolate bars for the school fundraiser, collect $10 if you were correct.” The player then adds $10 to their money tracking card (K) shown in FIG. 3 due to the correct answer given.

As play continues and the players dice toss results in a negative integer and therefore positioning his/her token shown in FIG. 3 on the “Equation Worksheet” segment, the player then would not have the opportunity to gain credit for that segment.

As play continues and the players dice toss results in a negative integer and therefore positioning his/her token shown in FIG. 3 on the “Free Lunch” segment, the player then would not have the opportunity to collect money from any other player for landing on that segment.

As play continues and the players dice toss results in a negative integer and therefore positioning his/her token shown in FIG. 3 on the “Geometry Test” segment, the player then would not have the opportunity to gain credit for that segment.

As play continues and the players dice toss results in a negative integer and therefore positioning his/her token shown in FIG. 3 on the “Pythagorean Quiz” segment, the player then would not have the opportunity to gain credit for that segment.

As play continues and the players dice toss results in a negative integer and therefore positioning his/her token shown in FIG. 3 on the “Cube Worksheet” segment, the player then would not have the opportunity to gain credit for that segment.

As play continues and the players dice toss results in a negative integer and therefore positioning his/her token shown in FIG. 3 on the “Baseball Diamond” segment, the player then would not have the opportunity to gain credit for that segment.

As play continues and the players dice toss results in a negative integer and therefore positioning his/her token shown in FIG. 3 on the “Perimeter Test” segment, the player then would not have the opportunity to gain credit for that segment.

As play continues and the players dice toss results in a negative integer and therefore positioning his/her token shown in FIG. 3 on the “Triangle Quiz” segment, the player then would not have the opportunity to gain credit for that segment.

As play continues and the players dice toss results in a negative integer and therefore positioning his/her token shown in FIG. 3 on the “Circle Worksheet” segment, the player then would not have the opportunity to gain credit for that segment.

As play continues and the players dice toss results in a negative integer and therefore positioning his/her token shown in FIG. 3 on the “Principal's Office” segment, they would not incur a penalty for landing on the segment because they are handing in attendance which is a designated segment within that segment. When a players token shown in FIG. 3 lands on the Principals Office they cannot attain this segment through a question because it has no value and therefore unattainable.

As play continues and the players dice toss results in a negative integer and therefore positioning his/her token shown in FIG. 3 on the “Addition Test” segment, the player then would not have the opportunity to gain credit for that segment.

As play continues and the players dice toss results in a negative integer and therefore positioning his/her token shown in FIG. 3 on the “Subtraction Quiz” segment, the player then would not have the opportunity to gain credit for that segment.

As play continues and the players dice toss results in a negative integer and therefore positioning his/her token shown in FIG. 3 on the “Library” segment, the player then would not have the opportunity to gain credit for that segment.

As play continues and the players dice toss results in a negative integer and therefore positioning his/her token shown in FIG. 3 on the “Square Root Worksheet” segment, the player then would not have the opportunity to gain credit for that segment.

As play continues and the players dice toss results in a negative integer and therefore positioning his/her token shown in FIG. 3 on the “Soccer Field” segment, the player then would not have the opportunity to gain credit for that segment.

As play continues and the players dice toss results in a negative integer and therefore positioning his/her token shown in FIG. 3 on the “Field Trip” segment, the player then would still pay the fine imposed for landing on the segment.

As play continues and the players dice toss results in a negative integer and therefore positioning his/her token shown in FIG. 3 on the “Percent Test” segment, the player then would not have the opportunity to gain credit for that segment.

As play continues and the players dice toss results in a negative integer and therefore positioning his/her token shown in FIG. 3 on the “Exponent Quiz” segment, the player then would not have the opportunity to gain credit for that segment.

If the players positive OR negative dice toss results in positioning his/her token shown in FIG. 3 on the “Exponent Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Percent Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3. If the players positive OR negative dice toss results in positioning his/her token shown in FIG. 3 on the “Soccer Field” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b.

If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Square Root Worksheet” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Library” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed.

Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Subtraction Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Addition Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Circle Worksheet” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed.

Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Triangle Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Perimeter Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Baseball Diamond” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Cube Worksheet” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Pythagorean Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed.

Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Geometry Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed.

Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Equation Worksheet” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3.

The player who had incurred the fee then subtracts that amount from their $250 money tracking card (K) shown in FIG. 3.

If the players positive OR negative dice toss results in positioning his/her token shown in FIG. 3 on the “Linear Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Variable Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token on the “School Playground” segment that is attained by another player the player then would have to pay the fee associated with that particular segment, including a higher fee for desks (N) shown in FIG. 3 and group tables (M) shown in FIG. 3.

The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Algebra Worksheet” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H). If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Coordinate Quiz” segment that is attained by another player the player then would have to pay the fee associated with that particular segment, including a higher fee for desks (N) and group tables (M). The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Cafeteria” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Graph Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Mean Worksheet” segment that is attained by another player the player then would have to pay the fee associated with that particular segment, including a higher fee for desks (N) shown in FIG. 3 and group tables (M) shown in FIG. 3.

The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Mode Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Median Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Basketball Court” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Chance Quiz” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed. Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

If the players positive OR negative dice toss results in positioning his/her token shown in FIG. 3 on the “Outcome Test” segment that is attained by another player the player then would have to pay the fee associated with that particular segment, including a higher fee for desks (N) shown in FIG. 3 and group tables (M) shown in FIG. 3. The player may use scrap paper to try and figure out the fee if needed.

Once a fee is figured out and is given, the owner of the segment may challenge the fee if they feel it may be incorrect and the secretary can check the provided answer on the Title Deed answer sheet (H) shown in FIG. 2, 2a, 2b. If it has been determined that the fee given is correct the owner then receives the fee for that segment and adds it to their $250 money tracking card (K) shown in FIG. 3. The player who had incurred the fee then subtracts that amount from their $250 money tracking card (K) shown in FIG. 3.

It shall be known, that the present Instructional mathematics board game may also be adapted for play for the blind individuals; by having Braille indicia on the cards, playing surface and dice. Thereby having a sighted, low vision, visually impaired, and/or blind players challenging each other.

In summary, the present Instructional mathematics board game in its various embodiments provides a means of playing a game, utilizing die of various configurations. A more advanced play may utilize two or more dice of various configurations, or combinations of, and that a particular educational and entertaining board game is provided by the present invention.

Those skilled in the art will appreciate from the abovementioned description, that the present Instructional mathematics board game has all the advantages of the prior art and none of the disadvantages and is extremely versatile and perhaps enjoyed by individuals of all ages and interests.

Therefore, the foregoing is considered as illustrative only of the principals of the invention. Further, since numerous modifications and changes will readily occur to those skilled in the art, it is not preferred to limit the invention to the exact construction and operation shown and described. Accordingly, all suitable modifications and equivalents may be resorted to falling within the scope of the following claims.

It shall be acknowledged; that it is possible for a player to produce a random integer with the dice in FIG. 6, which will allow a player to move forward or backward on game board.

In the present disclosure, the term “die or dice” respectively refers to at least one regular polyhedron die, each having a plurality of equally sized and shaped faces upon which a series of continuous numbers are placed and being equivalent to the number of faces of the polyhedron.

The polyhedrons may be tetrahedron having four sides, or a cube having six sides, as in dice shown in FIG. 6, or an octahedron having eight sides, or dodecahedron having twelve sides, or icosahedrons having twenty sides. Any of the above described configurations; either single or plural, maybe used for plays in the present game.

In the present disclosure, the term “card or cards” respectively refers to a card as in FIG. 5(a and b) with two faces having written indicia and/or numerical indicia and/or insignia thereon.

The invention is not limited to any plurality of strand cards per set. Plurality may include a set of strand cards related to mathematical problems arriving within but not limited to politics, music, sports, religion, history, current affairs, drama, education, profession, trades etc. Subject matter or theme of the board game may vary, and may comprise of many categories of subject matter.

After all players have completed a single round of play, the players may compare their scores, with the player having the most money winning the game, as in accordance with the seventh step of FIG. 9.

The present dice game may also utilize a timer to limit the length of play, with the winner determined by the player with the most money when the time limit has expired winning the game, in accordance with the fourth step of FIG. 9.

It shall also be known, that the present dice game may also be adaptable for the education, profession, and trade system or any field that requires training or certificate of achievement as examples given below.

It shall also be known, that the present dice game may be adapted to a study game for individuals, wherein; subject matter corresponds to a particular field of training, i.e. Numbers path strand question cards may be used to test the knowledge of that strand, wherein player may be able to achieve more knowledgeable information by; quizzing him/her self with question/answer cards pertaining to their particular field of training.

What is claim is:

1. A method of playing a mathematical board game comprising of the following steps:
(a) providing at least two dice having a plurality of different faces with corresponding different number means disposed on each of the said faces; and
(b) providing at least two play tokens; and
(c) providing a consecutive series of outer segments; and
(d) providing a consecutive series of inner segments; and
(e) providing at least one mathematical path for subject matter; and
(f) providing at least one set of strand question cards of subject matter; and
(g) providing at least one answer key chart of subject matter; and
(h) providing at least one mathematical graph of subject matter; and
(i) providing at least one mathematical tool pertaining to subject matter; and
(j) providing at least one title deed card; and
(k) providing at least one desk; and
(l) providing at least one group table; and
(m) providing at least one money tracking card; and
(n) providing at least one formula sheet; and
(o) setting a predetermined time limit; and
(p) selecting at least a first player and a second player and determining an order of play; and
(q) tossing at least two dice by the first player and generating random positive integer and; thereby
(r) moving forward the player's token according to the random positive integer generated by dice toss; or
(s) moving backwards the players token if the round is completed and it's the first players turn again according to the random integer generated by dice toss; and
(t) allowing the player an opportunity to answer segment question on said path according to the random positive integer generated by dice toss; and
(u) therefore if answered correctly the player pays fee associated with purchase of segment on said path; or
(v) allowing the player to forfeit the opportunity to answer segment question on said path; or
(w) compel the player to pay fee associated with segment on said path according to the random integer generated by the dice toss; or
(x) having the player pay a fee associated with the ownership of segment by another player on said path; and
(y) decreasing said amount from money tracking card; or
(z) increasing said amount to money tracking card; and
(aa) passing both dice to the second player in order of play to continue the game.

2. A method of playing a mathematical board game as defined in claim 1, including the steps of:
(a) providing a game board including a plurality of outer segments; and
(b) providing a plurality of inner segments; and
(c) providing a plurality of strand descriptors; and
(d) providing a plurality of strand question card segments; and
(e) providing a mental math segment; and
(f) providing a problem solving segment; and
(g) providing a game tile segment.

3. A method of playing a mathematical board game as defined in claim 1, of providing at least one tetrahedron die having four sides, with each said side including a different integer from one through four.

4. A method of playing a mathematical board game as defined in claim 1, of providing at least one cube die having six sides, with each said side including a different integer from one through six.

5. A method of playing a mathematical board game as defined in claim 1, of providing at least one Braille dice having six sides, with each said side including a different pip from one through six.

6. A method of playing a mathematical board game as defined in claim 1, of providing at least one octahedron die having eight sides, with each said side including a different integer from one through eight.

7. A method of playing a mathematical board game as defined in claim 1, of providing at least one decahedron die having ten sides, with each said side including a different integer from one through ten.

8. A method of playing a mathematical board game as defined in claim 1, of providing at least one dodecahedron die having twelve sides, with each said side including a different integer from one through twelve.

9. A method of playing a mathematical board game as defined in claim 1, of providing at least one icosahedron die having twenty sides, with each said side including a different integer from one through twenty.

10. A method of playing a mathematical board game as defined in claim 1, wherein each outer segment has a monetary dollar figure which may also include Braille indicia.

11. A method of playing a mathematical board game as defined in claim 1, wherein each outer segment has insignia, indicia and may also include Braille indicia.

12. A method of playing a mathematical board game as defined in claim 1, wherein each inner segment has indicia which may also include Braille indicia.

13. A method of playing a mathematical board game as defined in claim 1, wherein an inner segment has catch the bus indicia and insignia, which may also include Braille indicia.

14. A method of playing a mathematical board game as defined in claim 1, wherein an inner segment has exponent quiz indicia, which may include Braille indicia.

15. A method of playing a mathematical board game as defined in claim 1, wherein an inner segment has mental math indicia and insignia, which may also include Braille indicia.

16. A method of playing a mathematical board game as defined in claim 1, wherein an inner segment has percent test indicia, which may include Braille indicia.

17. A method of playing a mathematical board game as defined in claim 1, wherein an inner segment has field trip indicia and insignia, which may also include Braille indicia.

18. A method of playing a mathematical board game as defined in claim 1, wherein an inner segment has soccer field indicia, which may include Braille indicia.

19. A method of playing a mathematical board game as defined in claim 1, wherein an inner segment has square root worksheet indicia, which may include Braille indicia.

20. A method of playing a mathematical board game as defined in claim 1, wherein an inner segment has library indicia and insignia, which may include Braille indicia.

21. A method of playing a mathematical board game as defined in claim 1, wherein an inner segment has subtraction quiz indicia, which may include Braille indicia.

22. A method of playing a mathematical board game as defined in claim 1, wherein an inner segment has addition test indicia, which may include Braille indicia.

23. A method of playing a mathematical board game as defined in claim 1, wherein an inner segment has handing in attendance indicia, which may include Braille indicia.

24. A method of playing a mathematical board game as defined in claim 1, wherein an inner segment has circle worksheet indicia, which may include Braille indicia.

25. A method of playing a mathematical board game as defined in claim 1, wherein an inner segment has problem solving indicia and insignia, which may include Braille indicia.

26. A method of playing a mathematical board game as defined in claim 1, wherein an inner segment has triangle quiz indicia, which may include Braille indicia.

27. A method of playing a mathematical board game as defined in claim 1, wherein an inner segment has perimeter test indicia, which may include Braille indicia.

28. A method of playing a mathematical board game as defined in claim 1, wherein an inner segment has baseball diamond indicia, which may include Braille indicia.

29. A method of playing a mathematical board game as defined in claim 1, wherein an inner segment has cube worksheet indicia, which may include Braille indicia.

30. A method of playing a mathematical board game as defined in claim 1, wherein an inner segment has Pythagorean quiz indicia, which may include Braille indicia.

31. A method of playing a mathematical board game as defined in claim 1, wherein an inner segment has geometry test indicia, which may include Braille indicia.

32. A method of playing a mathematical board game as defined in claim 1, wherein an inner segment has free lunch indicia and insignia, which may include Braille indicia.

33. A method of playing a mathematical board game as defined in claim 1, wherein an inner segment has equation worksheet indicia, which may include Braille indicia.

34. A method of playing a mathematical board game as defined in claim 1, wherein an inner segment has linear quiz indicia, which may include Braille indicia.

35. A method of playing a mathematical board game as defined in claim 1, wherein an inner segment has variable test indicia, which may include Braille indicia.

36. A method of playing a mathematical board game as defined in claim 1, wherein an inner segment has school playground indicia, which may include Braille indicia.

37. A method of playing a mathematical board game as defined in claim 1, wherein an inner segment has algebra worksheet indicia, which may include Braille indicia.

38. A method of playing a mathematical board game as defined in claim 1, wherein an inner segment has coordinate quiz indicia, which may include Braille indicia.

39. A method of playing a mathematical board game as defined in claim 1, wherein an inner segment has cafeteria indicia and insignia, which may include Braille indicia.

40. A method of playing a mathematical board game as defined in claim 1, wherein an inner segment has graph test indicia, which may include Braille indicia.

41. A method of playing a mathematical board game as defined in claim 1, wherein an inner segment has go directly to the principal's office indicia and insignia, which may include Braille indicia.

42. A method of playing a mathematical board game as defined in claim 1, wherein an inner segment has mean worksheet indicia, which may include Braille indicia.

43. A method of playing a mathematical board game as defined in claim 1, wherein an inner segment has mode quiz indicia, which may include Braille indicia.

44. A method of playing a mathematical board game as defined in claim 1, wherein an inner segment has median test indicia, which may include Braille indicia.

45. A method of playing a mathematical board game as defined in claim 1, wherein an inner segment has basketball court indicia, which may include Braille indicia.

46. A method of playing a mathematical board game as defined in claim 1, wherein an inner segment has chance quiz indicia, which may include Braille indicia.

47. A method of playing a mathematical board game as defined in claim 1, wherein an inner segment has art fees indicia and insignia, which may include Braille indicia.

48. A method of playing a mathematical board game as defined in claim 1, wherein an inner segment has outcome test indicia, which may include Braille indicia.

49. A method of playing a mathematical board game as defined in claim 1, wherein one mathematical path will include a number path indicia, which may include Braille indicia.

50. A method of playing a mathematical board game as defined in claim 1, wherein one mathematical path will include a shape and space indicia, which may include Braille indicia.

51. A method of playing a mathematical board game as defined in claim 1, wherein one mathematical path will include a pattern and relation indicia, which may include Braille indicia.

52. A method of playing a mathematical board game as defined in claim 1, wherein one mathematical path will include a statistic and probability indicia, which may include Braille indicia.

53. A method of playing a mathematical board game as defined in claim 1, wherein at least one strand question may include questions related to shape and space, which may include Braille indicia.

54. A method of playing a mathematical board game as defined in claim 1, wherein at least one strand question may include questions related to pattern and relation, which may include Braille indicia.

55. A method of playing a mathematical board game as defined in claim 1, wherein at least one strand question may include questions related to statistics and probability, which may include Braille indicia.

56. A method of playing a mathematical board game as defined in claim 1, wherein at least one strand question may include questions related to numbers, which may include Braille indicia.

57. A method of playing a mathematical board game as defined in claim 1, of providing at least one answer key chart of subject matter which may include indicia, insignia and Braille indicia.

58. A method of playing a mathematical board game as defined in claim 1, of providing at least one mathematical graph of subject matter which may include indicia, insignia and Braille indicia.

59. A method of playing a mathematical board game as defined in claim 1, of providing at least one mathematical tool pertaining to subject matter which may include indicia and Braille indicia.

60. A method of playing a mathematical board game as defined in claim 1, of providing at least one title deed card which may include indicia, insignia and Braille indicia.

61. A method of playing a mathematical board game as defined in claim 1, wherein at least one of said title deed card having two faces and may include a mathematical question on one face of said faces to determine a fee related to segment, and may include indicia, insignia and Braille indicia on at least one face of said faces.

62. A method of playing a mathematical board game as defined in claim 1, wherein at least one of said title deed card having two faces which may include a mathematical question on one face of said faces to determine a one desk fee related to segment, and may include indicia, insignia and Braille indicia on at least one face of said faces.

63. A method of playing a mathematical board game as defined in claim 1, wherein at least one of said title deed card having two faces which may include a mathematical question on one face of said faces to determine a two desk fee related to segment, and may include indicia, insignia and Braille indicia on at least one face of said faces.

64. A method of playing a mathematical board game as defined in claim 1, wherein at least one of said title deed card having two faces which may include a mathematical question on one face of said faces to determine a three desk fee related to segment, and may include indicia, insignia and Braille indicia on at least one face of said faces.

65. A method of playing a mathematical board game as defined in claim 1, wherein at least one of said title deed card having two faces which may include a mathematical question on one face of said faces to determine a four desk fee related to segment, and may include indicia, insignia and Braille indicia on at least one face of said faces.

66. A method of playing a mathematical board game as defined in claim 1, wherein at least one of said title deed card having two faces which may include a mathematical question on one face of said faces to determine a group table fee related to segment, and may include indicia, insignia and Braille indicia.

67. A method of playing a mathematical board game as defined in claim 1, wherein at least one of said title deed card having two faces which may include a mathematical question on one face of said faces to determine a fee to purchase a desk(s) related to segment, and may include indicia, insignia and Braille indicia on at least one face of said faces.

68. A method of playing a mathematical board game as defined in claim 1, wherein at least one of said title deed card having two faces which may include a mathematical question on one face of said faces to determine a fee to purchase a group table related to segment, and may include indicia, insignia and Braille indicia on at least one face of said faces.

69. A method of playing a mathematical board game as defined in claim 1, of providing at least one desk which may include Braille indicia.

70. A method of playing a mathematical board game as defined in claim 1, wherein each desk has a plurality of sides and may include Braille indicia.

71. A method of playing a mathematical board game as defined in claim 1, wherein each desk may be circular and may include Braille indicia

72. A method of playing a mathematical board game as defined in claim 1, of providing at least one group table which may include Braille indicia.

73. A method of playing a mathematical board game as defined in claim 1, wherein each group table has a plurality of sides and may include Braille indicia.

74. A method of playing a mathematical board game as defined in claim 1, wherein each group table may be circular and may include Braille indicia.

75. A method of playing a mathematical board game as defined in claim 1, wherein at least one money tracking card having two faces which may include a numerical value on one face of said faces and may include indicia, insignia and Braille indicia on at least one face of said faces.

76. A method of playing a mathematical board game as defined in either claim 1 or 75, wherein the money tracking card is utilized for increasing or decreasing currency.

77. A method of playing a mathematical board game as defined in claim 1, of providing at least one formula sheet having two faces which may include indicia, insignia and Braille indicia on at least one face of said faces.

78. A method of playing a mathematical board game as defined in either claim 1 or 77, wherein the formula sheet is utilized for clarification of mathematical formulas and concepts.

79. A method of playing a mathematical board game as defined in claim 1, of providing a time limit for the game and playing in turn until reaching the time limit, with the player having the largest sum of money on their money tracking card wins the game.

80. A method of playing a mathematical board game as defined in claim 1, of providing a time limit for the game and playing in turn until reaching the time limit, with the player having owned the most amount of segments wins the game.

81. A method of playing a mathematical board game as defined in claim 1, including the step of determining an order of play by two or more players by tossing the dice and subtracting the lower valued die from the higher valued die and the player with the highest positive integer goes first.
